(19) United States
(12) Patent Application Publication
(10) Pub. No.: US 2024/0246111 A1
(43) Pub. Date: Jul. 25, 2024

(54) COATING APPARATUS

(71) Applicant: ENATECH CORPORATION, Osaka (JP)

(72) Inventors: Hideto YOSHIZUKA, Osaka (JP); Takao MATSUYAMA, Osaka (JP)

(21) Appl. No.: 18/290,371

(22) PCT Filed: May 12, 2022
(86) PCT No.: PCT/JP2022/020107

§ 371 Date: Nov. 13, 2023

(30) Foreign Application Priority Data
May 14, 2021 (JP) 2021-082592

(51) Int. Cl. B05C 13/02; B05C 1/02; B05C 11/04

(52) U.S. Cl. CPC B05C 13/02; B05C 1/027; B05C 11/048

(57) ABSTRACT

A coating apparatus, which coats only the outer circumferential edge face of a workpiece with film-forming liquid, even if the workpiece is a non-circular thin lens or the like, a rotating mechanism is configured so that a workpiece and an imitating form having the same shape as the outer shape of the workpiece can rotate synchronously around the same rotation axis center, a coating mechanism includes a pressing roller that can rotate with the imitating form while being pressed against an outer circumferential edge face of the imitating form, and a coating part including a coating roller which, while being pressed against the outer circumferential edge face of the workpiece, rotates with the workpiece and applies the film forming liquid to the outer circumferential edge face of the workpiece, a rotary transmission unit that synchronously rotates the pressing roller and the coating roller having the same outer shape.

### TECHNICAL FIELD

The present invention relates to a coating apparatus, and more particularly, to a coating apparatus which is able to coat the outer circumferential edge face of a workpiece of various shapes, such as a noncircular lens, with film-forming liquid.

### BACKGROUND ART

The manufacturing process of optical instruments such as cameras and microscopes include the application of antireflection paint (e.g., black paint) to the periphery of the lens to prevent phenomena such as flare and ghosting that occur when incident light on the lens used in these optical instruments is reflected on the lens surface or outer lens surface. This coating process is also known as the black-coating process.

Since lenses used for the optical instruments come in various sizes and shapes, automation of the black-coating process is not easy. In addition, since the black-coating process requires high application precision, it is often applied manually by skilled workers using instruments such as brushes, making it difficult to improve work efficiency.

In view of these issues, coating apparatus for improving the efficiency of the coating process are disclosed, for example, in the following Patent Document 1 and 2.

The coating apparatus described in Patent Document 1 is configured to apply a coating material such as black ink to the periphery of a disc-shaped roll, transfer the coating material applied to the roll to the periphery of a disc-shaped transfer roll, and then apply the coating material transferred to the transfer roll to the periphery of a lens.

However, the roll transfer coating system described in Patent Document 1 cannot apply said coating material to optical elements that are not circular in shape, such as elliptic-format lenses, in a single process to the entire periphery.

In order to solve this problem, in the coating apparatus described in Patent Document 2, a cam of the same shape as the outer shape of the elliptic-format lens is fixed to the suction cylinder that holds the elliptic-format lens, a coating tip made of porous material is provided at the periphery of the elliptic-format lens, and a cam follower is provided at a position in contact with the cam. The cam follower is mounted on a lower slide table pressed by a lower spring via a cam base, and an upper slide table pressed by an upper spring is provided above the lower slide table, and the coating tip is mounted on the upper slide table via a tip holder.

According to the coating apparatus described in Patent Document 2, the cam, cam follower, lower slide table, and lower spring can adjust the distance from the coating tip to the lens coating surface in synchronization with the rotation of the elliptic-format lens, thereby automating the coating process for the periphery surface of the non-circular elliptic-format lens.

### Problems to be Solved by the Invention

In recent years, in addition to the optical lenses for cameras and microscopes mentioned above, there has been a demand for the development of apparatus that can precisely apply light-shielding material to the outer circumferential edge face of non-circular thin lenses such as so-called smart glasses (glasses-type wearable devices), which display various information on the lens portion.

For example, assuming that the coating apparatus described in Patent Document 2 is used to apply the light-shielding material to the outer circumferential edge face of the thin lens, the coating apparatus described in Patent Document 2 will apply the light-shielding material by pressing the coating tip made of porous material against the outer circumferential edge face of the thin lens.

When using the coating apparatus described in Patent Document 2, the coating tip made of porous material is pressed against the outer circumferential edge face of the thin lens, so that the light-shielding material is applied not only to the outer circumferential edge face of the thin lens but also to the outer circumferential edge part, making it impossible to accurately apply said light-shielding material only to the outer circumferential edge face of the thin lens, in other words, with a coating width less than the thickness of the lens.

### PRIOR ART DOCUMENT

### Patent Document

Patent Document 1: Japanese Patent Application Laid-Open Publication No. 1994-142577
Patent Document 2: Japanese Patent Application Laid-Open Publication No. 1999-156260

### SUMMARY OF THE INVENTION

### Solution to Problem and Advantageous Effect of Invention

The present invention was developed in order to solve the above problem, and it is an object of the present invention to provide a coating apparatus, which make it possible to precisely coat only the outer circumferential edge face of a workpiece with film-forming liquid according to the outer shape of the workpiece, even if the workpiece is a non-circular thin lens or the like.

In order to achieve the above object, a coating apparatus according to a first aspect of the present invention is characterized by comprising a rotating mechanism that rotates a workpiece and a coating mechanism that applies the film-forming liquid to the outer circumferential edge face of the workpiece comprising:
the rotating mechanism can synchronously rotate the workpiece and the imitating form having almost identical outline to the outline of the workpiece, at the same rotating axis center; and
the coating mechanism comprising:
a pressing roller that can rotate with the imitating form while being pressed against the outer circumferential edge face of the imitating form;
a coating part including a coating roller that is pressed against the outer circumferential edge face of the workpiece and rotates with the workpiece to apply the film-forming liquid to the outer circumferential edge face of the workpiece; and
a rotary transmission unit that synchronously rotates the pressing roller and the coating roller, which have almost identical outline.

Using the coating apparatus according to the first aspect of the present invention, the rotating mechanism enables synchronized rotation of the workpiece and the imitating form having almost the same outline and the same rotating axis center.

By the coating mechanism, the pressing roller and the coating roller are pressed against the outer circumferential edge face of the imitating form and the workpiece, respectively. It is possible to synchronously rotate the pressing roller and the coating roller, which have almost identical outline, by means of the rotary transmission unit.

Therefore, the rotational motion of the imitating form and the pressing roller can be synchronized with the rotational motion of the workpiece and the coating roller.

The presence of the imitating form enables the coating roller to contact the outer circumferential edge face of the workpiece according to the shape of the workpiece (in other words, regardless of the shape of the workpiece) while rotating the coating roller.

It is also possible to precisely apply the film-forming liquid to the outer circumferential edge face of the workpiece with a coating width less than the thickness of the workpiece.

Even if the workpiece is thin and prone to damage such as cracks and breaks, the presence of the imitating form limits the pressing force of the coating roller against the outer circumferential edge face of the workpiece and prevents damage to the workpiece.

The coating apparatus according to a second aspect of the present invention is characterized by the coating mechanism comprising:
a copying position adjustment mechanism that enables adjustment of the position of the pressing roller so that it moves along the outer circumferential edge face of the imitating form, while synchronizing the change in the distance from the center of rotation of the imitating form to the contact point between the imitating form and the pressing roller accompanied by rotation of the imitating form according to the first aspect of the present invention.

Using the coating apparatus according to the second aspect of the present invention, even when the distance from the center of rotation of the imitating form to the contact point between the imitating form and the pressing roller changes as the imitating form rotates (for example, when the workpiece and imitating form are non-circular), the position of the pressing roller is adjusted accurately by the copying position adjustment mechanism in synchronization with the change in distance so that the pressing roller rotates with the outer edge of the imitating form pressed against it.

The position of the coating roller will also be precisely adjusted in synchronization with this operation, so that the coating roller rotates with the coating roller pressed against the outer circumferential edge face of the workpiece, in synchronization with the change in distance.

Therefore, even if the workpiece is not only circular but also non-circular, the film-forming liquid can be precisely applied to the outer circumferential edge face of the workpiece with a coating width less than the thickness of the workpiece.

The coating apparatus according to a third aspect of the present invention is characterized by the copying position adjustment mechanism comprising:
a moving mechanism that enables the attaching member to which the pressing roller, the coating part and the rotary transmission unit are operably attached to move in a first direction along a straight line connecting the center of rotation of the imitating form and the center of rotation of the pressing roller; and
a pressing adjustment part that enables the pressing adjustment of the attaching member attached to the moving mechanism in the first direction according to the second aspects of the present invention.

Using the coating apparatus according to the third aspect of the present invention, the moving mechanism enables the attaching member to move in the first direction, and the pressing adjustment part enables the attaching member attached to the moving mechanism to adjust the pressure in the first direction.

Therefore, the attaching member can be moved in the first direction with the pressing roller, the coating part, and the rotation transmission mechanism integrated and with the pressing roller pressed against the imitating form so that it moves along the outer circumferential edge face of the imitating form.

This prevents misalignment of the axis of rotation of the pressing roller and the coating roller during the coating operation, and further improves the accuracy of the operation of pressing the coating roller against the workpiece so that it moves along the outer circumference shape of the workpiece.

The coating apparatus according to a fourth aspect of the present invention is characterized by the coating mechanism comprising:
a coating roller pressing part, which adjust the power of pressing coating roller to the outer circumferential edge face of the workpiece according to any one of the first through third aspects of the present invention.

Using the coating apparatus according to the fourth aspect of the present invention, the coating roller pressing part moderately adjusts the force with which the coating roller presses down on the outer circumferential edge face of the workpiece, so that the film-forming liquid can be applied to the outer circumferential edge face of the workpiece with a constant pressing force.

The coating apparatus according to a fifth aspect of the present invention is characterized by the coating roller pressing part comprising:
a elastic member, which arranged with variable force in a second direction along a straight line connecting the center of rotation of the workpiece and the center of rotation of the coating roller according to the fourth aspect of the present invention.

Using the coating apparatus according to the fifth aspect of the present invention, the elastic member can be adjusted so that the pressing force of the coating roller against the workpiece is less than the pressing force of the pressing roller against the imitating form.

Therefore, the film-forming liquid can be precisely applied to the outer circumferential edge face of the workpiece with the desired coating width and thickness while the coating roller is lightly pressed against the outer circumferential edge face of the workpiece. It can also enhance the prevention of damage to the workpiece.

The coating apparatus according to a sixth aspect of the present invention is characterized by the rotary transmission unit comprising:
a first transmission unit for transmitting the rotation of the pressing roller;
a second transmission unit for transmitting the rotation from the first transmission unit; and
a third transmission unit for transmitting the rotation from the second transmission unit to the coating roller, wherein the first transmission unit comprises:
a first rotary transmission part for rotating together with the shaft of rotation of the pressing roller, wherein the second transmission unit comprises:
a first rotary transmission shaft which is attached to a second rotary transmission part rotating synchronously with the first rotary transmission part at one end and a third rotary transmission part rotating synchronously with the second rotary transmission part at the other end, wherein the third transmission unit comprises:
a fourth rotary transmission part which is attached to the rotating shaft of the coating roller and rotates synchronously with the third rotary transmission part; and
a swaying arm that supports the rotating shaft of the coating roller in a form that enables the coating roller to sway around the first rotary transmission shaft according to any one of the first through fifth aspects of the present invention.

Using the coating apparatus according to the sixth aspect of the present invention, the rotation of the pressing roller is synchronously transmitted to the coating roller via the first rotary transmission unit, the second rotary transmission unit, the first rotary transmission shaft, the third rotary transmission unit, and the fourth rotary transmission unit, and the coating roller is supported in a swayable form by the swaying arms around the first rotary transmission shaft.

The configuration is such that the rotation of the pressing roller is synchronously transmitted to the coating roller, and the force to press the coating roller against the outer circumferential edge face of the workpiece is easily adjusted.

The coating apparatus according to a seventh aspect of the present invention is characterized by the coating part comprising:
a liquid supply section to supply film-forming liquid to the outer circumferential edge face of the coating roller; and
a liquid scraper provided with a coating groove to form a coating width less than or equal to the thickness of the workpiece and arranged to be in contact with the outer circumferential edge face of the coating roller according to any one of the first through sixth aspects of the present invention.

Using the coating apparatus according to the seventh aspect of the present invention, the film-forming liquid is supplied from the liquid supply section to the outer circumferential edge face of the coating roller, and as the coating roller rotates, the liquid scraping section scrapes off the film-forming liquid in areas other than the coating groove areas, so that a linear film-forming liquid in the form of a coating groove is precisely applied to the outer circumferential edge face of the coating roller.

Therefore, by rotating the workpiece and the coating roller in the companion direction with the outer circumferential edge face portion of the coating roller coated with the linear film-forming liquid pressed against the outer circumferential edge face of the workpiece, the linear film-forming liquid is transferred to the outer circumferential edge face of the workpiece.

Since the coating groove is shaped to form a coating width less than the thickness of the workpiece, the film-forming liquid can be precisely applied to the outer circumferential edge face of the workpiece with a coating width less than the thickness of the workpiece.

The coating apparatus according to an eighth aspect of the present invention is characterized by the rotating mechanism comprising:
a holding part to hold the workpiece; and
a imitating form attachment part to which the imitating form is removably attached according to any one of the first through seventh aspects of the present invention.

Using the coating apparatus according to the eighth aspect of the present invention, the workpiece is held in the holding section and the imitating form can be attached to and detached from the imitating form mounting section.

Therefore, the workpieces can be easily replaced and, depending on the type of workpieces, the imitating forms can be installed with a shape that is almost identical to the outer shape of these workpieces. Therefore, a single apparatus can repeatedly coat the outer circumferential edge faces of many types of workpieces with different shapes, highly versatile apparatus can be realized.

The coating apparatus according to a ninth aspect of the present invention is characterized by the rotating mechanism comprising:
a first rotating shaft connecting the holding part and the imitating form attachment part; and
a second rotating shaft connected coaxially to the first rotating shaft and rotatable by a rotary drive force from a driver, wherein
the holding part, the first rotating shaft and the second rotating shaft have a suction path for adsorbing and holding the workpiece in the holding part according to the eighth aspect of the present invention.

Using the coating apparatus according to the ninth aspect of the present invention, the rotating mechanism is configured so that the first and second rotation shafts are connected on the same axis, allowing easy attachment and removal of the imitating form to and from the imitating form attachment section. Since the suction path is formed, the workpiece can be suctioned and held in the holding section, and the workpiece can be easily attached and detached.

The coating apparatus according to a tenth aspect of the present invention is characterized by the outer circumference length of the pressing roller is longer than the outer circumference length of the imitating form according to any one of the first through ninth aspects of the present invention.

Using the coating apparatus according to the tenth aspect of the present invention, since the outer circumference length of the pressing roller is longer than the outer circumference length of the imitating form, the rotation of the pressing roller is less than one revolution when the imitating form makes one revolution. So, during one revolution of the pressing roller, in other words, during one revolution of the coating roller, the film-forming liquid can be applied to the entire circumference of the outer circumferential edge face of the workpiece.

The coating apparatus according to an eleventh aspect of the present invention is characterized by the rotary transmission unit comprising:
a fourth transmission unit that has a fifth rotary transmission part having the same outline as the coating roller and enables synchronized rotation of the fifth rotary transmission part and the coating roller around the same rotating axis center; and
a fifth transmission unit that enables synchronized rotation of the pressing roller and the fifth rotary transmission part according to any one of the first through fifth aspects of the present invention.

Using the coating apparatus according to the eleventh aspect of the present invention, the fifth transmission mechanism synchronously rotates the pressing roller and the fifth rotation transmission unit, and the rotation of the fifth rotation transmission unit is synchronously transmitted to the coating roller via the fourth transmission mechanism. Therefore, the fifth transmission mechanism and the fourth transmission mechanism can reliably rotate the pressing roller and the coating roller synchronously. And the rotational motion of the imitating form, which rotates together with the pressing roller, and the rotational motion of the workpiece, which rotates together with the coating roller, can also be synchronized.

The coating apparatus according to a twelfth aspect of the present invention is characterized by the fifth transmission unit comprising:
a sixth rotary transmission part that can rotate together with the pressing roller;
a seventh rotary transmission part that has the same outline as the sixth rotary transmission part and can rotate together with the fifth rotary transmission part; and
a second rotary transmission shaft that enables synchronized rotation of the sixth and seventh rotary transmission part according to the eleventh aspects of the present invention.

Using the coating apparatus according to the twelfth aspect of the present invention, the sixth and seventh rotary transmission part rotate synchronously via the second rotary transmission shaft, which causes the pressing roller and the fifth rotary transmission section to rotate synchronously, and the rotation of the fifth rotary transmission part is transmitted synchronously to the coating roller by the fourth transmission mechanism. Therefore, it is possible to synchronously rotate the pressing roller and the coating roller with high accuracy using a simple configuration.

The coating apparatus according to a thirteenth aspect of the present invention is characterized by the second rotary transmission shaft comprising a deflectable shaft or a universal joint according to the twelfth aspects of the present invention.

Using the coating apparatus according to a thirteenth aspect of the present invention, the second rotary transmission shaft is configured with a deflectable shaft or with a universal joint, so that even if some misalignment (eccentricity) occurs in the axial direction of rotation between the pressing roller and the coating roller during coating operation, the pressing roller and the coating roller can be rotated synchronously with high accuracy while absorbing or mitigating the misalignment.

The coating apparatus according to a fourteenth aspect of the present invention is characterized by the rotary transmission unit comprising:
a eighth rotary transmission part rotatable together with the sixth rotary transmission part; and
a driving part that rotates and drives the eighth rotary transmission part according to the twelfth or thirteenth aspects of the present invention.

Using the coating apparatus according to the fourteenth aspect of the present invention, by driving the eighth rotary transmission part by the driving part, the rotational force of the eighth rotary transmission part is transmitted to the pushing roller via the sixth rotary transmission part. The rotational force of the eighth rotary transmission part is transmitted to the fifth rotary transmission part via the sixth rotary transmission part, the second rotary transmission shaft, and the seventh rotary transmission part, and then from the fifth rotary transmission part to the coating roller via the fourth transmission unit.

Therefore, the rotational drive force of the driving part is transmitted to the pressing roller and the coating roller, and the pressing roller and the coating roller can be rotated synchronously with high accuracy.

The coating apparatus according to a fifteenth aspect of the present invention is characterized by a tooth profile is formed on the outer circumference face of each of the imitating form, the pressing roller, the fifth rotary transmission part, the sixth rotary transmission part, the seventh rotary transmission part and the eighth rotary transmission part, which can be engaged with each other according to the fourteenth aspects of the present invention.

Using the coating apparatus according to the fifteenth aspect of the present invention, the imitating form, the pressing roller, the fifth rotary transmission part, the sixth rotary transmission part, the seventh rotary transmission part, and the eighth rotary transmission part each have tooth profiles on their outer circumference face that can be engaged with each other, thereby reducing synchronization timing deviations and increasing synchronization accuracy can be reached.

The coating apparatus according to a sixteenth aspect of the present invention is characterized by the fifth transmission unit comprising:
a sixth rotary transmission part that can rotate together with the pressing roller;
a seventh rotary transmission part that has the same outline as the sixth rotary transmission part and can rotate together with the fifth rotary transmission part;
a first driving part that rotates and drives the sixth rotary transmission part; and
a second driving part that rotates and drives the seventh rotary transmission part according to the eleventh aspects of the present invention.

Using the coating apparatus according to the sixteenth aspect of the present invention, the rotary driving force of the first driving part is transmitted to the pressing roller via the sixth rotational transmission part, the rotary driving force of the second driving part is transmitted to the fifth rotary transmission part via the seventh rotary transmission part, and the rotation of the fifth rotary transmission part is synchronously transmitted to the coating roller by the fourth transmission unit.

Therefore, it is possible to synchronously rotate the pressing roller and the coating roller with high accuracy by means of a configuration that synchronizes the rotary drive of the first driving part and the second driving part.

The coating apparatus according to a seventeenth aspect of the present invention is characterized by a tooth profile is formed on the outer circumference face of each of the imitating form, the pressing roller, the fifth rotary transmission part, the sixth rotary transmission part, and the seventh rotary transmission part, which can be engaged with each other according to the sixteenth aspects of the present invention.

Using the coating apparatus according to the seventeenth aspect of the present invention, the imitating form, the pressing roller, the fifth rotary transmission part, the sixth rotary transmission part, and the seventh rotary transmission part each have tooth profiles on their outer circumference face that can be engaged with each other, thereby reducing synchronization timing deviations and increasing synchronization accuracy can be reached.

The coating apparatus according to a eighteenth aspect of the present invention is characterized by the fifth transmission unit comprising:
a sixth rotary transmission part that can rotate together with the pressing roller;
a seventh rotary transmission part that has the same outline as the sixth rotary transmission part and can rotate together with the fifth rotary transmission part;
a eighth rotary transmission part rotatable together with the sixth rotary transmission part:
a first driving part that rotates and drives the eighth rotary transmission part;
a ninth rotary transmission part rotatable together with the seventh rotary transmission part: and
a second driving part that rotates and drives the ninth rotary transmission part according to the eleventh aspects of the present invention.

Using the coating apparatus according to the eighteenth aspect of the present invention, the rotary driving force of the first driving part is transmitted to the pressing roller via the eighth rotary transmission part and the sixth rotary transmission part, the rotary driving force of the second driving part is transmitted to the fifth rotary transmission part via the ninth and seventh rotary transmission part, and the rotation of the fifth rotary transmission part is synchronously transmitted to the coating roller by the fourth transmission unit.

Therefore, it is possible to synchronously rotate the pressing roller and the coating roller with high accuracy by means of a configuration that synchronizes the rotary drive of the first driving part and the second driving part.

The coating apparatus according to a nineteenth aspect of the present invention is characterized by a tooth profile is formed on the outer circumference face of each of the imitating form, the pressing roller, the fifth rotary transmission part, the sixth rotary transmission part, the seventh rotary transmission part, the eighth rotary transmission part and the ninth rotary transmission part, which can be engaged with each other according to the eighteenth aspects of the present invention.

Using the coating apparatus according to the nineteenth aspect of the present invention, the imitating form, the pressing roller, the fifth rotary transmission part, the sixth rotary transmission part, the seventh rotary transmission part, the eighth rotary transmission part, and the ninth rotary transmission part each have tooth profiles on their outer circumference face that can be engaged with each other, thereby reducing synchronization timing deviations and increasing synchronization accuracy can be reached.

The coating apparatus according to a twentieth aspect of the present invention is characterized by the rotary transmission unit comprising:
a first driving part that rotates and drives the pressing roller; and
a second driving part that rotates and drives the coating roller according to any one of the first through fifth aspects of the present invention.

Using the coating apparatus according to the twentieth aspect of the present invention, the rotary driving force of the first driving part is transmitted to the pressing roller, and the rotary driving force of the second driving part is transmitted to the coating roller.

Therefore, it is possible to synchronously rotate the pressing roller and the coating roller with high accuracy by synchronizing the rotary drive of the first driving part and the second driving part.

And the rotational motion of the imitating form, which rotates together with the pressing roller, and the rotational motion of the workpiece, which rotates together with the coating roller, can also be synchronized.

The coating apparatus according to a twenty first aspect of the present invention is characterized by the imitating form is shaped with a curved section on its periphery, the radius of the pressing roller is set to be less than or equal to the minimum radius of curvature of the curved section of the imitating form according to any one of the eleventh through twentieth aspects of the present invention.

Using the coating apparatus according to the twenty first aspect of the present invention, the radius of the pressing roller is set below the minimum radius of curvature of the curved sections of the imitating form, so that even if the imitating form has a shape with a plurality of curved sections with different degrees of curvature, the pressing roller can be accurately copied by pressing it against all the curved sections of the imitating form.

Therefore, the film-forming liquid can be precisely applied to the outer circumferential edge face of the workpiece (i.e. having a plurality of the curved sections with different degrees of curvature), which has the same approximate shape as the imitating form, with the coating roller, which has the same approximate shape as the pressing roller.

The coating apparatus according to a twenty second aspect of the present invention is characterized by a pressing roller guide is mounted on the imitating form, the pressing roller guide is configured to guide the pressing roller along the curved section of the imitating form according to the twenty first aspects of the present invention.

Using the coating apparatus according to the twenty second aspect of the present invention, the pressing rollers can be securely guided along the curved section of the imitating form with the pressing rollers pressed against the curved section, even if the curved section of the imitating form has a large degree of curvature, by providing the pressing roller guide.

This allows the coating roller to precisely apply the film-forming liquid to the outer circumferential edge face of the workpiece, even if the workpiece has a curved shape with a large degree of curvature.

The coating apparatus according to a twenty third aspect of the present invention is characterized by the rotating mechanism comprising:
a holding part to hold the workpiece;
a third rotating shaft with a holding part attachable on one end and a imitating form attachable on the other end; and
a support part that rotatably supports the third rotating shaft, wherein
the holding part and the third rotating shaft have a suction path for adsorbing and holding the workpiece in the holding part according to any one of the eleventh through twenty second aspects of the present invention.

Using the coating apparatus according to the twenty third aspect of the present invention, the third rotating shaft is rotatably supported by the support part, and the holding part attachable is provided at one end of the third rotating shaft and the imitating form attachable is provided at the other end, so that the holding part and the imitating form can be easily attached and detached. The suction path is formed so that the workpiece can be held in the holding part by suction, and the workpiece can be easily attached or detached.

The coating apparatus according to a twenty fourth aspect of the present invention is characterized by the thickness of the outer circumferential edge face of the coating roller is less than or equal to the thickness of the outer circumferential edge face of the workpiece, wherein the coating part comprises:
a liquid supply section to supply the film-forming liquid to the outer circumferential edge face of the coating roller;
a liquid expansion part arranged to be in contact with the outer circumferential edge face of the coating roller; and
a liquid scraper arranged to be in contact with the outer circumferential edge face of the coating roller according to any one of the eleventh through twenty third aspects of the present invention.

Using the coating apparatus according to the twenty fourth aspect of the present invention, the liquid supply section, the liquid expansion part, and the liquid scraper enable the film-forming liquid to adhere to the outer circumferential edge surface of the coating roller only, spreading the film-forming liquid without the film-forming liquid protruding from the outer circumferential edge surface.

The coating apparatus according to a twenty fifth aspect of the present invention is characterized by the liquid expansion part has a plurality of micro-grooves formed in the direction of rotation of the coating roller on the contact surface with the outer circumferential edge face of the coating roller according to the twenty fourth aspects of the present invention.

Using the coating apparatus according to the twenty fifth aspect of the present invention, the liquid expansion part is provided with a plurality of micro-grooves on the contact surface with the outer circumferential edge face of the coating roller, so that the film-forming liquid can adhere to the outer circumferential edge face of the coating roller while spreading it thinly and even. The coating the outer circumferential edge face of the workpiece can also be performed more neatly.

### BRIEF DESCRIPTION OF DRAWINGS

FIG. 1 is a plan view showing an essential part configuration of the coating apparatus according to a first embodiment of the present invention;

FIG. 2 is a cross-sectional view showing an essential part of the II-II line in FIG. 1;

FIG. 3 is a cross-sectional view showing an essential part of the III-III line in FIG. 1;

FIG. 4 is a figure showing an example of a workpiece, (a) is a plan view and (b) is a b-b cross section in (a);

FIG. 5 is a figure showing an example of a imitating form, (a) is a plan view and (b) is a b-b cross section in (a);

FIG. 6 (a) to (c) are schematic diagrams to explain the operation of the imitating form and the pressing roller during the coating operation by the coating apparatus according to a first embodiment of the present invention;

FIG. 7 (a) to (d) are schematic diagrams to explain the operation of the workpiece and the coating roller during the coating operation by the coating apparatus according to a first embodiment of the present invention;

FIG. 8 is a plan view showing an essential part configuration of the coating apparatus according to a second embodiment of the present invention;

FIG. 9 is a cross-sectional view showing an essential part of the IX-IX line in FIG. 8;

FIG. 10 is a cross-sectional view showing an essential part during the coating operation of the IX-IX line;

FIG. 11 is a cross-sectional view showing an essential part of the XI-XI line in FIG. 10;

FIG. 12 is a cross-sectional view showing an essential part of the XII-XII line in FIG. 10;

FIG. 13 is a cross-sectional view showing an essential part of the XIII-XIII line in FIG. 10;

FIG. 14 is a figure showing an example of a workpiece, (a) is a plan view and (b) is a b-b cross section in (a);

FIG. 15 is a figure showing an example of a imitating form, (a) is a plan view and (b) is a b-b cross section in (a);

FIG. 16 (a) to (c) are schematic diagrams to explain the operation of the imitating form and the pressing roller during the coating operation by the coating apparatus according to a second embodiment of the present invention;

FIG. 17 (a) to (d) are schematic diagrams to explain the operation of the workpiece and the coating roller during the coating operation by the coating apparatus according to a second embodiment of the present invention;

FIG. 18 is a cross-sectional view showing an essential part configuration of the coating apparatus according to another embodiment of the present invention; and

FIG. 19 is a cross-sectional view showing an essential part configuration of the coating apparatus according to yet another embodiment of the present invention.

### DESCRIPTION OF EMBODIMENTS

The preferred embodiments of the coating apparatus according to the present invention are described below by reference to the Figures.

The following embodiments of the invention are suitable specific examples of the invention and are subject to various technically preferred limitations, but the scope of the invention is not limited to these embodiments unless specifically stated to limit the invention in the following description.

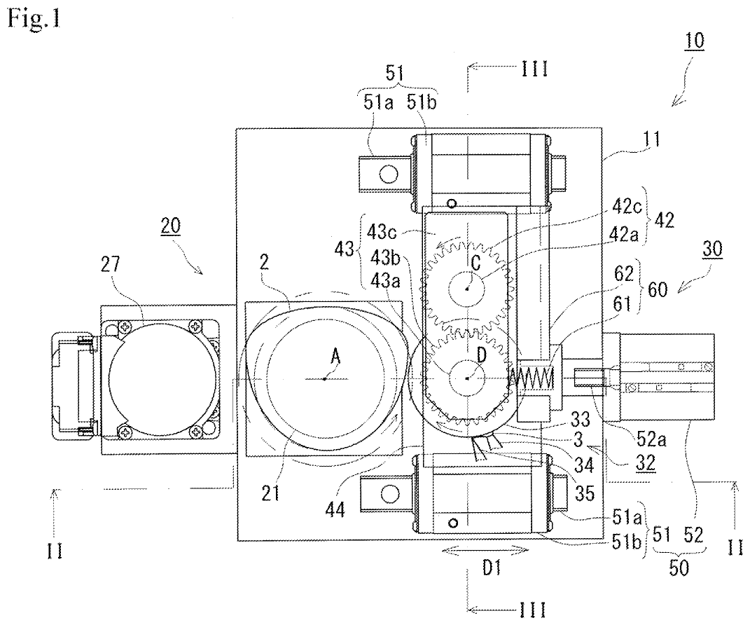

FIG. 1 is a plan view showing an essential part configuration of the coating apparatus according to a first embodiment of the present invention;

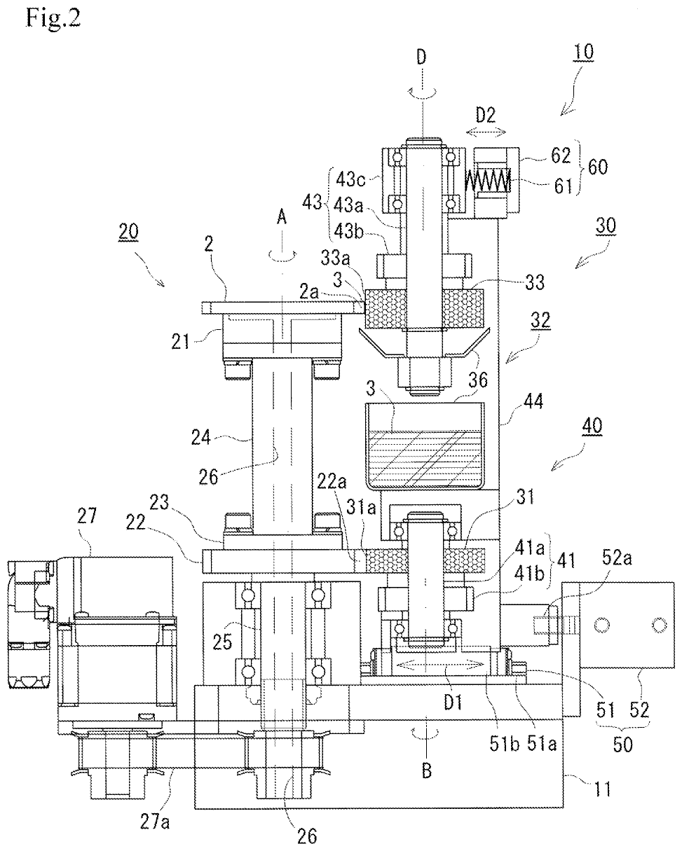

FIG. 2 is a cross-sectional view showing an essential part of the II-II line in FIG. 1; and

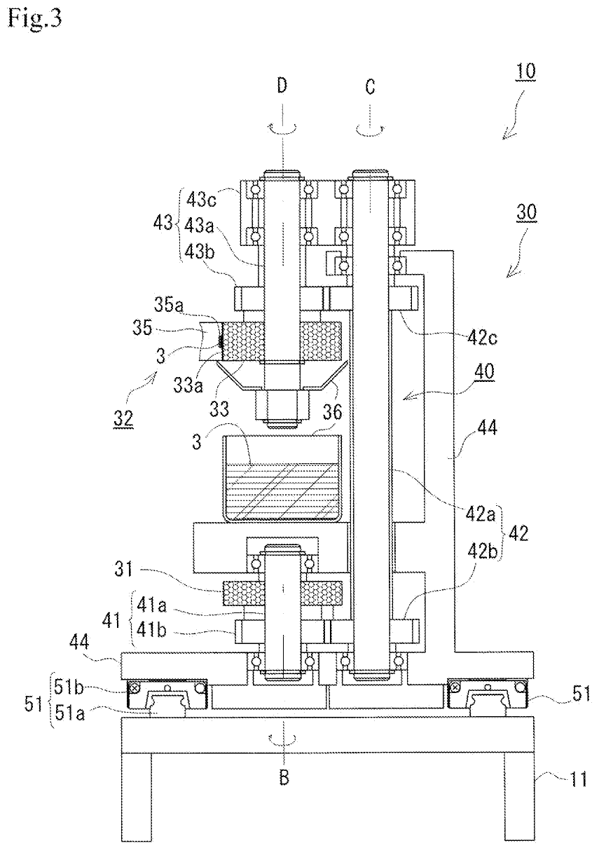

FIG. 3 is a cross-sectional view showing an essential part of the III-III line in FIG. 1.

In FIGS. 2 and 3, hatching showing cross sections is omitted for convenience of illustration.

A coating apparatus 10 is a device that allows film-forming liquid 3 to be applied with precision only to the outer circumferential edge face 2a (FIG. 2) of a workpiece 2. the coating apparatus 10 has a rotating mechanism 20 that rotates the workpiece 2 and a coating mechanism 30 that applies the film-forming liquid 3 to the outer circumferential edge face 2a of the workpiece 2 that is rotated by the rotating mechanism 20. the rotating mechanism 20 and the coating mechanism 30 are located at the support base 11.

In the present embodiment, it is assumed that the workpiece 2 to be coated is a thin lens with a non-circular shape for smart glasses, but the type, shape, size, etc. of the workpiece 2 are not limited to this.

Applicable the workpiece 2 can include various types of thin-plate-shaped components such as glass, lenses, mirrors, films, plastics and other resins, metals, or electronic circuit boards, regardless of whether they are circular or noncircular.

The rotating mechanism 20 has a holding part 21 that holds the workpiece 2 and a imitating form attachment part 23 to which a imitating form 22, which has the same external shape as the workpiece 2, is attached. The workpiece 2 held by the holding part 21 and the imitating form 22 attached to the imitating form attachment part 23 can rotate synchronously around the same rotating axis (A-axis).

The rotating mechanism 20 comprises a first rotating shaft 24, which connects the holding part 21 and the imitating form attachment part 23, and a second rotating shaft 25, which is connected to the first rotating shaft 24 on the same axis (A axis) and can be rotated by rotational driving power from a driver 27. The driver 27 consists of a high-precision rotary motor, such as a servo motor, for example, and the rotary driving power of the driver 27 is transmitted to the second rotating shaft 25 via a belt pulley mechanism 27a. The second rotating shaft 25 is mounted in a bearing, such as a ball bearing, for example.

Rotation control of the second rotating shaft 25 by the driver 27 may be performed at a constant rotational speed, or rotational control may be performed at a varying rotational speed depending on the shape of the imitating form 22.

The holding part 21, the first rotating shaft 24, and the second rotating shaft 25 are formed with a suction path 26 for holding the workpiece 2 in the holding part 21 by suction, and a vacuum device such as a vacuum pump or ejector, not shown, is connected to the lower end portion of the second rotating shaft 25, which allows suction operation by the vacuum device.

Thus, the holding part 21 functions as a table to suction and hold the workpiece 2. The configuration is such that the workpiece 2 is precisely positioned and placed on the top surface of the holding part 21 in an orientation that overlaps the imitating form 22 in plan view using an industrial robot such as a handling robot, which is not shown in the figure.

The imitating form 22 is configured to be detachable from the imitating form attachment part 23, and in the present embodiment, the second rotating shaft 25 is inserted and attached to the center of rotation of the imitating form 22. The imitating form 22 is, for example, made of metal and molded into the same shape as the outline of the workpiece 2.

The coating mechanism 30 consists of a pressing roller 31 (FIGS. 2 and 3), a coating part 32 including a coating roller 33, a rotary transmission unit 40 (FIGS. 2 and 3), a imitating position adjustment mechanism 50, and a coating roller pressing part 60.

The pressing roller 31 is pressed against a outer circumferential edge face 22a of the imitating form 22 and is axially supported on a pressing roller rotating shaft 41a so that it rotates about the center of the B axis according to the rotation of the imitating form 22 by the rotating mechanism 20.

The pressing roller 31, for example, is made of metal, has a predetermined hardness, and its outer surface has a predetermined surface roughness to enable it to rotate in companion with the imitating form 22.

The coating roller 33 is axially supported by a coating roller rotating shaft 43a so that it is pressed against the outer circumferential edge face 2a of the workpiece 2 and applies the film-forming liquid 3 with a coating width less than the thickness of the workpiece 2 and rotating about the center of the D axis. The coating roller 33 is, for example, made of metal.

The pressing roller 31 and the coating roller 33 are circular in plan view and have the same external shape. The outline size of the pressing roller 31 is preferably designed so that its outer circumference length is longer than that of the imitating form 22.

According to this configuration, the coating roller 33, which has the same outline as the pressing roller 31, can apply the film-forming liquid 3 to the entire circumference of the outer circumferential edge face 2a of the workpiece 2 during one rotation.

The coating part 32 also has a liquid supply section 34, a liquid scraper part 35, and a liquid receiver 36 (FIGS. 2 and 3) located near the outer surface of the coating roller 33.

The liquid supply section 34 comprises a mechanism for supplying the film-forming liquid 3 to a outer circumferential edge face 33a of the coating roller 33, such as a nozzle part that discharges 3 supplied from a liquid holding part, not shown, into the outer circumferential edge face 33a.

The liquid scraper part 35 has a coating groove 35a (FIG. 3) to form a coating width less than the thickness of the workpiece 2, and consists of a mechanism including a scraping plate (scraper) or the like that is arranged to be in contact with the outer circumferential edge face 33a of the coating roller 33. The excess the film-forming liquid 3 scraped off by the liquid scraper part 35 is collected in the liquid receiver 36.

The order of arrangement of the liquid supply section 34 and the liquid scraper part 35 is designed according to the direction of rotation of the coating roller 33 so that the film-forming liquid 3 fed from the liquid supply section 34 to the outer circumferential edge face 33a of the coating roller 33 is scraped off by the liquid scraper part 35.

The rotary transmission unit 40 is equipped with a mechanism that synchronously transmits the rotation of the pressing roller 31 to the coating roller 33. The rotary transmission unit 40 preferably comprises a first transmission unit 41 (FIGS. 2 and 3), which transmits the rotation of the pressing roller 31, the second transmission unit 42, which transmits the rotation from the first transmission unit 41, and the third transmission unit 43, which transmits the rotation from the second transmission unit 42 to the coating roller 33.

The first transmission unit 41 comprises the pressing roller rotating shaft 41a, which rotates with the pressing roller 31, and a first gear 41b, which is attached to the pressing roller rotating shaft 41a. The pressing roller rotating shaft 41a is attached to a bearing, for example, a ball bearing.

The second transmission unit 42 comprises a vertically oriented (first rotary transmission shaft) a rotary transmission shaft 42a, a second gear 42b attached to the lower end (one end side) of the rotary transmission shaft 42a, and the third gear 42c attached to the upper end (other end) of the rotary transmission shaft 42a.

The second gear 42b is meshed with the first gear 41b so as to rotate synchronously (companion rotation) with the first gear 41b, and the third gear 42c is mounted on the rotary transmission shaft 42a so as to rotate synchronously with the second gear 42b. The rotary transmission shaft 42a is mounted on a bearing, for example, a ball bearing.

The third transmission unit 43 consists of the coating roller rotating shaft 43a, which rotates with the coating roller 33, the fourth gear 43b, which is attached to the coating roller rotating shaft 43a, and a swaying arm 43c, which supports the coating roller rotating shaft 43a on a shaft in a form that allows the coating roller 33 to pivot around the rotary transmission shaft 42a.

The fourth gear 43b is meshed with the third gear 42c so as to rotate synchronously (companion rotation) with the third gear 42c. the coating roller rotating shaft 43a is mounted on a bearing, for example, a ball bearing.

In addition to the configuration in which the rotary transmission shaft 42a is composed of one shaft, the rotating shaft portion of the swaying arm 43c may be composed of another rotating shaft, and the rotary transmission shaft 42a may be divided into two rotating shafts to be rotated coaxially.

In the present embodiment, the first gear 41b and the second gear 42b are examples of the first and second rotary transmission parts, and the third gear 42c and the fourth gear 43b are examples of the third and fourth rotary transmission parts. It is preferable to use gears with minimal backlash (the gap between tooth flanks when gears are meshed) for the first gear 41b, the second gear 42b, the third gear 42c, and the fourth gear 43b, preferably gears with no backlash, in order to improve the accuracy of synchronous rotation.

In another configuration example, the first gear 41b and the second gear 42b may be configured with a mechanism using a toothed pulley and toothed belt, and similarly, the third gear 42c and the fourth gear 43b may be configured with a mechanism using a toothed pulley and toothed belt. In this case, too, it is preferable to use a toothed pulley and a toothed belt with minimal backlash, or more preferably, no backlash.

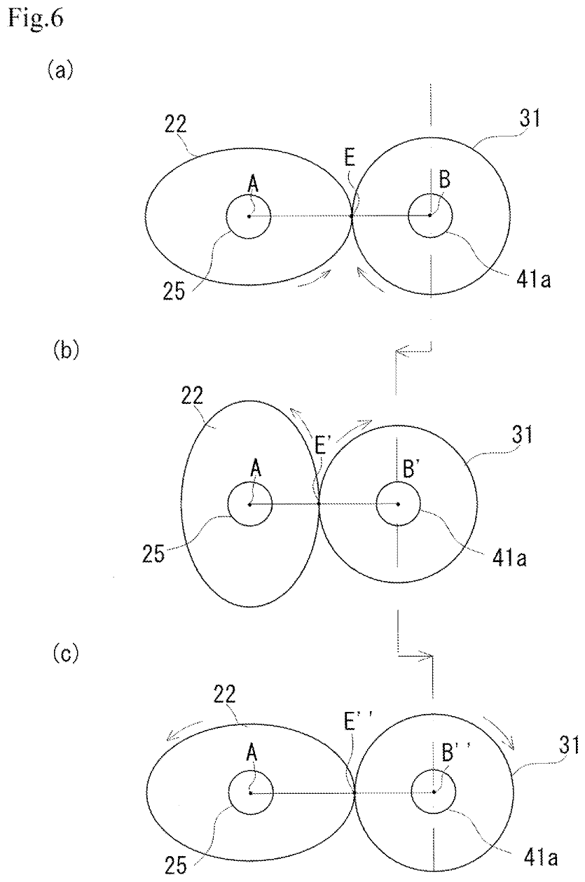

The imitating position adjustment mechanism 50 is a mechanism that allows the position of the pressing roller 31 to be adjusted to follow the outer circumferential edge face 22a of the imitating form 22 while synchronizing with changes in the distance AE from the center of rotation (axis A) of the imitating form 22 to the contact point E (FIG. 6) between the imitating form 22 and the pressing roller 31 with rotation of the imitating form 22.

In the present embodiment, the imitating position adjustment mechanism 50 consists of a moving mechanism 51 and an attaching member pressing part 52.

The moving mechanism 51 is a mechanism that allows a attaching member 44, to which the pressing roller 31, the coating part 32, and the rotary transmission unit 40 are operably attached, to move in the first direction D1 along the line AB (FIG. 6) connecting the center of rotation (A axis) of the imitating form 22 and the center of rotation (B axis) of the pressing roller 31 (FIGS. 2 and 3).

In the present embodiment, the moving mechanism 51 consists of two linear guide mechanisms arranged at predetermined intervals on the support base 11.

The two linear guide mechanisms comprising the moving mechanism 51 have a guide rail 51a and a slider 51b, respectively, which are arranged in the first direction D1 and move on the guide rail 51a. The base of the attaching member 44 is mounted on the slider 51b.

The attaching member pressing part 52 adjusts the pressure force to allow the attaching member 44 attached to the moving mechanism 51 to reciprocate in the first direction D1. In the present embodiment, the attaching member pressing part 52 comprises an air cylinder located at the support base 11, wherein a piston rod 52a of the air cylinder is oriented in the first direction D1 and the tip of the piston rod 52a is attached to the base of the attaching member 44.

By using an air cylinder as the attaching member pressing part 52, the configuration facilitates absorption or relaxation of the force when pressing the pressing roller 31 against the outer circumferential edge face 22a of the imitating form 22 in accordance with changes in the distance between the A and B axes due to the rotation of the imitating form 22. Pressing the pressing roller 31 to follow the shape of the outer circumference of the imitating form 22, become more smoothly.

The coating roller pressing part 60 allows adjustment of the force that presses the coating roller 33 onto the outer circumferential edge face 2a of the workpiece 2.

In the present embodiment, the coating roller pressing part 60 is located on the side of the swaying arm 43c opposite the side on which the rotating mechanism 20 is located. The coating roller pressing part 60 comprises a elastic member 61, which is positioned with variable force in the second direction D2 (FIG. 2) along the line AD connecting the center of rotation of the workpiece 2 (axis A) and the center of rotation of the coating roller 33 (axis D), and an attaching member 62, to which the elastic member 61 is attached.

The attaching member 62 is attached to the top of the attaching member 44. The elastic member 61 is composed of a compression coil spring, but may be composed of various spring members such as plate springs or other elastic materials such as air springs or rubber.

The following is a description of the operation of applying the film-forming liquid 3 to the outer circumferential edge face 2a of the workpiece 2 using the coating apparatus 10 according to the first embodiment.

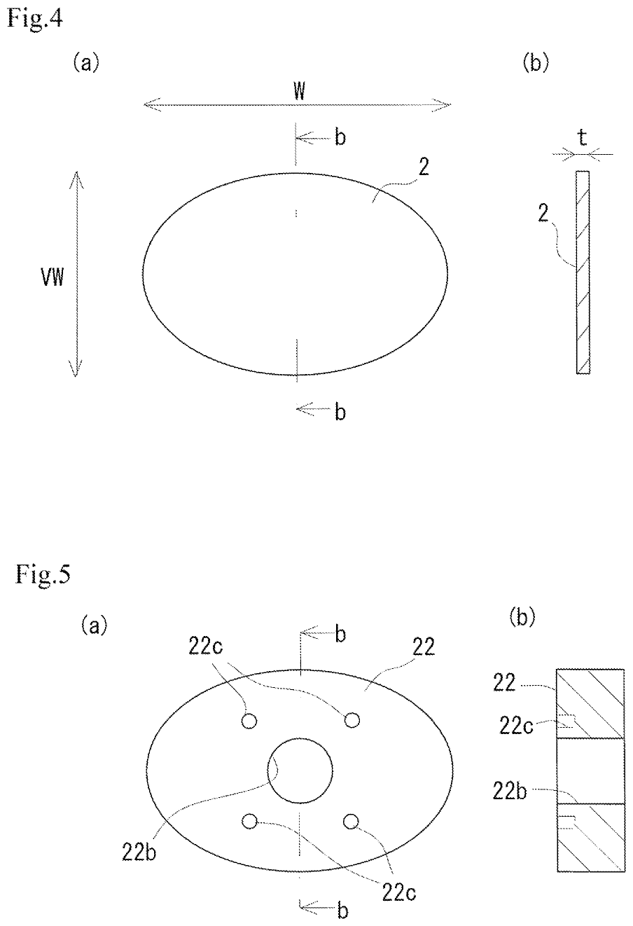

FIG. 4 is a figure showing an example of a workpiece, (a) is a plan view and (b) is a b-b cross section in (a). the workpiece 2 is a glass lens for smart glasses, for example, consisting of a non-circular lens with a width W of about the imitating position adjustment mechanism 50 to 60 mm, a height VW of about the coating mechanism 30 to 50 mm, and a thickness t of about 0.5 to 1 mm. The shape of the workpiece 2 is here an oval shape, but it may be an inverted trapezoidal or square shape.

FIG. 5 is a figure showing an example of a imitating form, (a) is a plan view and (b) is a b-b cross section in (a).

The imitating form 22 has the same shape as the outer shape of the workpiece 2. The insertion hole 22b is formed in the center of the imitating form 22 for insertion and attachment to the second rotating shaft 25 of the rotating mechanism 20, and a attachment hole 22c, a bolt or other fixture, is formed around the insertion hole 22b, and the imitating form 22 can be attached to and detached from the imitating form attachment part 23 using said fixture.

The imitating form 22 is prepared for each type (shape) of the workpiece 2. The imitating form 22 is preferably molded from a metal member. The imitating form 22 has a predetermined hardness and a predetermined surface roughness on its outer surface so that it can rotate around the pressing roller 31 in a companion rotation without misalignment (slippage). The imitating form 22 is preferably as thick as the thickness of the pressing roller 31.

First, to start the coating operation, the workpiece 2 is placed on the holding part 21 of the coating apparatus 10. The workpiece 2 is placed on the top surface of the holding part 21 by, for example, a handling robot, and is held in a suctioned position on the holding part 21.

The workpiece 2 is installed on the holding part 21 so that the center of rotation of the workpiece 2 is aligned with the center of rotation of the imitating form 22 (center of rotation (A axis) of the first rotating shaft 24 and the second rotating shaft 25) and the orientation of the workpiece 2 is aligned with the orientation of the imitating form 22 (so that the entire circumference of the workpiece 2 and the imitating form 22 overlap in plan view).

Although FIGS. 1 to 3 show the state during the coating operation, it is possible to drive the imitating position adjustment mechanism 50 to evacuate the attaching member 44 to a predetermined position so that the imitating form 22 and the pressing roller 31 are a predetermined distance apart (e.g., 10 mm) when the workpiece 2 are attached and detached.

Once the workpiece 2 is in place on the top of the holding part 21, the moving mechanism 51 and the attaching member pressing part 52 comprising the imitating position adjustment mechanism 50 are then driven to move the attaching member 44 so that the pressing roller 31 is pressed against the imitating form 22.

When the pressing roller 31 is pressed against the imitating form 22, the driver 27 of the rotating mechanism 20 is then driven, and the rotational driving force of the driver 27 drives the second rotating shaft 25 and the first rotating shaft 24 to rotate at a predetermined speed, and the imitating form 22 and the workpiece 2 begin to rotate synchronously.

When the imitating form 22 begins to rotate, the pressing roller 31, which is being pressed against the imitating form 22, begins to rotate in the companion direction to the imitating form 22. The rotation of the pressing roller 31 is then transmitted to the coating roller 33 via the rotary transmission unit 40 (i.e., the pressing roller rotating shaft 41a, the first gear 41b, the second gear 42b, the rotary transmission shaft 42a, the third gear 42c, the fourth gear 43b, and the coating roller rotating shaft 43a), and the coating roller 33 starts rotating synchronously with the pressing roller 31.

In synchronization with the rotation of the coating roller 33, a predetermined amount of the film-forming liquid 3 begins to be supplied from the liquid supply section 34 of the coating part 32 to the outer circumferential edge face 33a of the coating roller 33.

The supplied film-forming liquid 3 is scraped off by the liquid scraper part 35, and the film-forming liquid 3 is applied to the outer circumferential edge face 33a of the coating roller 33 in a linear pattern in the shape of the coating groove 35a (coating width and thickness). Then, the film-forming liquid 3 is applied to the outer circumferential edge face 2a of the workpiece 2 according to the rotation of the coating roller 33.

FIG. 6 is schematic diagrams to explain the operation of the imitating form 22 and the pressing roller 31 during the coating operation by the coating apparatus 10.

FIG. 6 (a) shows a scene in which the pressing roller 31 is pressed against the imitating form 22, the imitating form 22 rotates to the left by rotational power from the driver 27, and the pressing roller 31 rotates in a companion rotation (right rotation) following the rotation of the imitating form 22.

FIG. 6(b) shows the state when the imitating form 22 rotates 90 degrees left from the state in FIG. 6(a).

FIG. 6(c) shows the state when the imitating form 22 is rotated another 90 degrees to the left from the state in FIG. 6(b).

The direction of rotation indicated by the arrow in FIG. 6 is an example, and it is also possible to configure the coating apparatus to rotate in the opposite direction to that of the arrow shown in the figure.

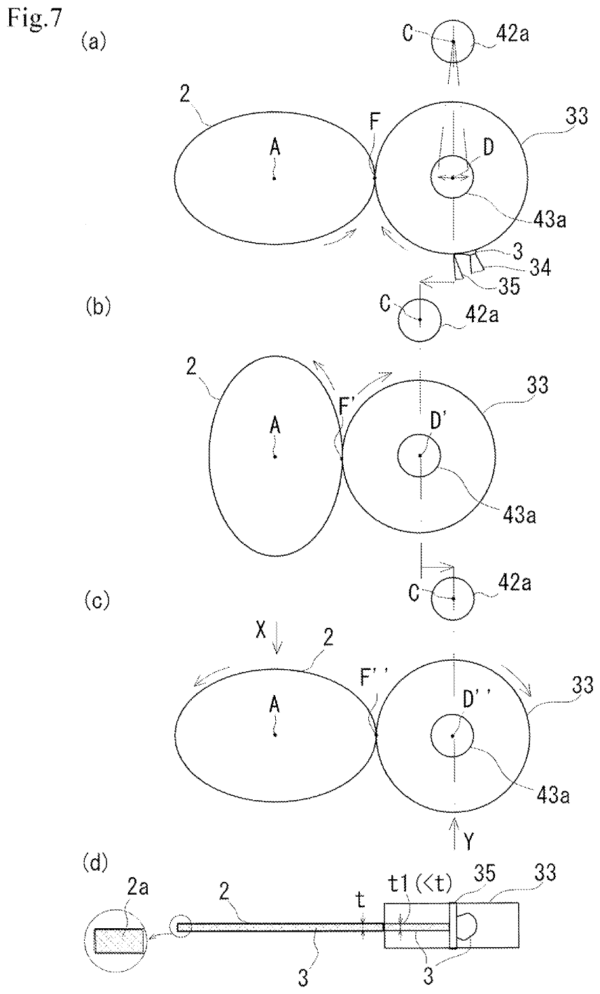

FIG. 7 is schematic diagrams to explain the operation of the workpiece 2 and the coating roller the coating roller 33 during the coating operation by the coating apparatus 10.

FIG. 7(a) shows a scene in which the coating roller 33 is pressed against the workpiece 2, the workpiece 2 rotates left under rotational power from the driver 27, and the coating roller 33 is applying the film-forming liquid 3 to the outer circumferential edge face 2a of the workpiece 2 while rotating (right) in synchronization with the rotation of the pressing roller 31 transmitted via the rotary transmission unit 40.

FIG. 7(b) shows the state when the workpiece 2 is rotated 90 degrees left from the state in FIG. 7(a).

FIG. 7(c) shows the state when the workpiece 2 is rotated another 90 degrees to the left from the state shown in FIG. 7(b).

FIG. 7(d) shows the side of the workpiece 2 and the side of the coating roller 33 as viewed from the arrow X and Y directions shown in FIG. 7(c).

FIG. 7(a) shows the same timing state as shown in FIG. 6(a); similarly, FIG. 7(b) shows the same timing state as shown in FIG. 6(b), and FIG. 7(c) shows the same timing state as shown in FIG. 6(c).

As shown in FIGS. 6 and 7, the imitating form 22 and the workpiece 2 rotate synchronously with the rotational drive of the rotating mechanism 20.

As shown in FIG. 6, since the imitating form 22 is non-circular, as the imitating form 22 rotates, the distances AE, AE′, AE′, AE″ from the center of rotation of the imitating form 22 (axis A) to the contact points E, E′, E″ of the imitating form 22 and the pressing roller 31 changes.

In the state shown in FIG. 6(b), the distance AE′ is shorter than the distance AE in the state shown in FIG. 6(a). The position of the attaching member 44 is then adjusted by the imitating position adjustment mechanism 50 so that the position of the center of rotation (B axis) of the pressing roller 31 moves from B to B′ in synchronization with the change from distance AE to distance AE′ as the imitating form 22 rotates.

In the state shown in FIG. 6(c), the distance is AE″, and the distance AE″ is longer than the distance AE′ in the state shown in FIG. 6(b). Then, synchronizing the change from distance AE′ to distance AE″ with the rotation of the imitating form 22, the attaching member 44 is adjusted by the imitating position adjustment mechanism 50 so that the position of the center of rotation (B axis) of the pressing roller 31 is shifted from B′ to B″.

Thus, the position of the pressing roller 31 is adjusted by the imitating position adjustment mechanism 50 so that the pressing roller 31 follows the outer circumferential edge face 22a of the imitating form 22, synchronizing with the change in the distance AE from the center of rotation (axis A) of the imitating form 22 to the point of contact E between the imitating form 22 and the pressing roller 31 as the imitating form 22 rotates.

The imitating form 22 and the workpiece 2 are arranged so that their centers of rotation are on the same axis (A axis) and their outer circumferences overlap each other in plan view, and the pressing roller 31 and the coating roller 33 are on the same axis (B and D axes) in the attaching member 44 where position adjustment is made by the imitating position adjustment mechanism 50.

Therefore, the operation with the workpiece 2 and the coating roller 33 shown in FIG. 7 is basically synchronized with the operation with the imitating form 22 and the pressing roller 31 shown in FIG. 6.

In other words, the position of the coating roller 33 (position of the center of rotation (D axis)) is adjusted by the imitating position adjustment mechanism 50 so that the coating roller 33 follows the outer circumferential edge face 2a of the workpiece 2, synchronizing the change in the distance AF from the center of rotation (A axis) of the workpiece 2 to the contact point F between the workpiece 2 and the coating roller 33 as the workpiece 2 rotates.

In addition, in the movement between the workpiece 2 and the coating roller 33, the force of the coating roller 33 against the outer circumferential edge face 2a of the workpiece 2 is adjustable by the elastic member 61 of the coating roller pressing part 60.

That is, in the attaching member 44, the pressing roller 31 and the coating roller 33 are arranged basically on the same axis (B and D axes), but the coating roller 33 is supported by the swaying arm 43c in a form that allows it to pivot around the rotary transmission shaft 42a. However, since the third gear 42c attached to the rotary transmission shaft 42a and the fourth gear 43b attached to the coating roller rotating shaft 43a are engaged, the swing range (angle) of the coating roller 33 is limited to a small range.

Since the swaying arm 43c is pressed by the elastic member 61 with variable force in the second direction D2 (FIG. 2), the pressing force when the coating roller 33 is pressed against the outer circumferential edge face 2a of the workpiece 2 can be relieved and absorbed by the elastic member 61.

Thus, it is possible to apply the film-forming liquid 3 with the coating roller 33 pressed against the outer circumferential edge face 2a of the workpiece 2 with less force than the pressing roller 31 is pressed against the outer circumferential edge face 22a of the imitating form 22.

As shown in FIG. 7(d), the film-forming liquid 3 supplied to the outer circumferential edge face 33a of the coating roller 33 is scraped off by the liquid scraper part 35 except for the area where the coating groove 35a (FIG. 3) is formed by the liquid scraper part 35, and is applied in a line with the shape of the coating groove 35a (coating width and thickness).

The size of the coating groove 35a is designed so that the coating width t1 of the film-forming liquid 3 applied in a linear pattern is less than or equal to the thickness t of the workpiece 2, and the coating thickness of the film-forming liquid 3 is less than several tens of micrometers, for example, for shading material. The shape of the coating groove 35a is set according to the type and thickness of the workpiece 2 and the type of the film-forming liquid 3.

Although FIG. 7(d) shows an example of a configuration in which the thickness of the coating roller 33 is greater than the thickness t of the workpiece 2, in another configuration example, the thickness of the coating roller 33 may be configured with a paint width of t1 less than the thickness t of the workpiece 2.

The outer circumferential edge face 33a portion of the coating roller 33 with the linear film-forming liquid 3 applied is pressed against the outer circumferential edge face 2a of the workpiece 2 while rotating, so that the film-forming liquid 3 is applied (transferred) to the outer circumferential edge face 2a of the workpiece 2 with a coating width of less than the thickness t of the workpiece 2 and with a predetermined coating thickness.

According to the coating apparatus 10 in the first embodiment, the rotating mechanism 20 allows synchronized rotation of the workpiece 2 held in the holding part 21 and the imitating form 22 attached to the imitating form attachment part 23 at the same rotation axis (A-axis) center.

By the coating mechanism 30, the pressing roller 31 is rotated according to the rotation of the imitating form 22 with the pressing roller 31 pressed against the imitating form 22, and the rotation of the pressing roller 31 is transmitted synchronously to the coating roller 33 by the rotary transmission unit 40.

Therefore, with the coating roller 33 rotating synchronously with the pressing roller 31 and the coating roller 33 pressed against the outer circumferential edge face 2a of the workpiece 2 rotating synchronously with the imitating form 22, the film-forming liquid 3 is applied to the outer circumferential edge face 2a of the workpiece 2 with a coating width less than the thickness of the workpiece 2.

Even if the distance AE from the center of rotation (axis A) of the imitating form 22 to the contact point E between the imitating form 22 and the pressing roller 31 changes with the rotation of the imitating form 22, which has a non-circular shape, the position of the pressing roller 31 is adjusted by the imitating position adjustment mechanism 50 in synchronization with the change in distance AE so that the pressing roller 31 rotates with the pressing roller 31 pressed against the outer circumferential edge face 22a of the imitating form 22, and the force pressing the coating roller 33 onto the outer circumferential edge face 2a of the workpiece 2 is adjusted by the coating roller pressing part 60.

Therefore, even if the workpiece 2 is not only circular but also noncircular, the film-forming liquid 3 can be precisely applied to the outer circumferential edge face 2a of the workpiece 2 with a coating width less than the thickness t of the workpiece 2.

According to the coating apparatus 10, the imitating position adjustment mechanism 50 comprises the moving mechanism 51 and the attaching member pressing part 52, wherein the moving mechanism 51 allows the attaching member 44 to move in the first direction D1 and the attaching member pressing part 52 allows the attaching member 44 attached to the moving mechanism 51 to be pressure adjusted in the first direction D1.

Thus, the attaching member 44 can be moved in the first direction D1 with the pressing roller 31, the coating part 32, and the rotary transmission unit 40 integrated and with the pressing roller 31 pressed against the imitating form 22 so that it moves along the circumferential shape of the imitating form 22.

This prevents misalignment of the rotational axes (B and D axes) of the pressing roller 31 and the coating roller 33 during the coating operation, and further improves the accuracy of the operation to press the coating roller 33 against the workpiece 2 to move along the outer circumferential edge face 2a.

According to the coating apparatus 10, the coating roller pressing part 60 is equipped with the elastic member 61, so that the elastic member 61 can adjust (relieve or absorb) the pressure force of the coating roller 33 against the workpiece 2 to be less than the pressure force of the pressing roller 31 against the imitating form 22.

Therefore, with the coating roller 33 lightly pressed against the outer circumferential edge face 2a of the workpiece 2, the film-forming liquid 3 can be accurately applied to the outer circumferential edge face 2a of the workpiece 2 with the desired coating width and thickness.

According to the coating apparatus 10, the rotation of the pressing roller 31 is synchronously transmitted to the coating roller 33 via the first gear 41b, the second gear 42b, the rotary transmission shaft 42a, the third gear 42c, and the fourth gear 43b, which constitute the rotary transmission unit 40, and the coating roller 33 is configured to be pivotally supported by the swaying arm 43c with the rotary transmission shaft 42a as a center.

This configuration enables a configuration in which the rotation of the pressing roller 31 is transmitted synchronously to the coating roller 33 and in which the force to push the coating roller 33 against the outer circumferential edge face 2a of the workpiece 2 can be easily adjusted.

According to the coating apparatus 10, since the coating part 32 is equipped with the liquid supply section 34 and the liquid scraper part 35, the film-forming liquid 3 is supplied from the liquid supply section 34 to the outer circumferential edge face 33a of the coating roller 33, and as the coating roller 33 rotates, the film-forming liquid 3 is scraped off the portions except for the portion of the coating groove 35a by the liquid scraper part 35, so that a linear the film-forming liquid 3 in the shape of the coating groove 35a is precisely applied and formed on the outer circumferential edge face 33a of the coating roller 33.

Therefore, by rotating the workpiece 2 and the coating roller 33 in the companion direction with the outer circumferential edge face 33a portion of the coating roller 33 with the linear film-forming liquid 3 applied pressed against the outer circumferential edge face 2a of the workpiece 2, the linear film-forming liquid 3 is transferred to the outer circumferential edge face 2a of the workpiece 2 and the film-forming liquid 3 can be applied to the outer circumferential edge face 2a of the workpiece 2 with precision with a coating width less than the thickness of the workpiece 2.

According to the coating apparatus 10, the rotating mechanism 20 is configured so that the first rotating shaft 24 and the second rotating shaft 25 are connected on the same axis (A axis), which makes it easy to attach the imitating form 22 to the imitating form attachment part 23, and the suction path 26 is formed so that the workpiece 2 can be adsorbed and held in the holding part 21.

According to the coating apparatus 10, since the pressing roller 31 and the coating roller 33 have the same external shape, the rotational cycles of the pressing roller 31 and the coating roller 33 can be synchronized with the rotation of the imitating form 22 and 2, and the application to the outer circumferential edge face 2a of the workpiece 2 by the coating roller 33 can be performed with high accuracy.

According to the coating apparatus 10, the circumferential length of the pressing roller 31 is longer than the circumferential length of the imitating form 22, so that even if the imitating form 22 makes one rotation, the rotation of the pressing roller 31 is less than one revolution, and thus the film-forming liquid 3 can be applied to the outer circumferential edge face 2a of the workpiece 2 during one rotation of the pressing roller 31.

According to the coating apparatus 10, since the imitating form 22 is configured to be detachable from the imitating form attachment part 23, for each type of the workpiece 2, the imitating form 22 of the same shape as the outer shape of these workpieces can be attached. A single apparatus can perform application to the outer edge surfaces of many types of workpieces with different shapes, making it a highly versatile apparatus.

In the coating apparatus 10 for the first embodiment, the rotational transmission force of the driver 27 is transmitted to the second rotating shaft 25 via the belt pulley mechanism 27a, but the form of drive by the driver 27 is not limited to this.

In another embodiment, the rotational transmission force of the driver 27 may be transmitted to the rotary transmission shaft 42a of the rotary transmission unit 40 via a belt pulley mechanism or gears. Alternatively, the second gear 42b and the third gear 42c may be configured to drive and control the rotary shafts of the second gear 42b and the third gear 42c, respectively, to rotate synchronously at separate the driver 27 without connecting them at the rotary transmission shaft 42a.

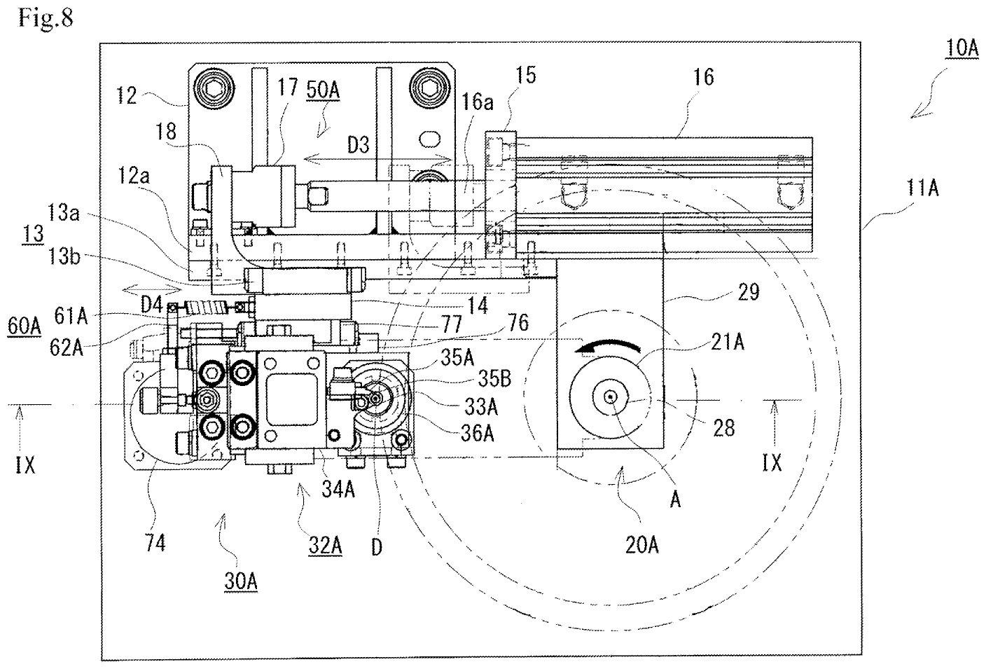

FIG. 8 is a plan view showing an essential part configuration of the coating apparatus according to a second embodiment of the present invention;

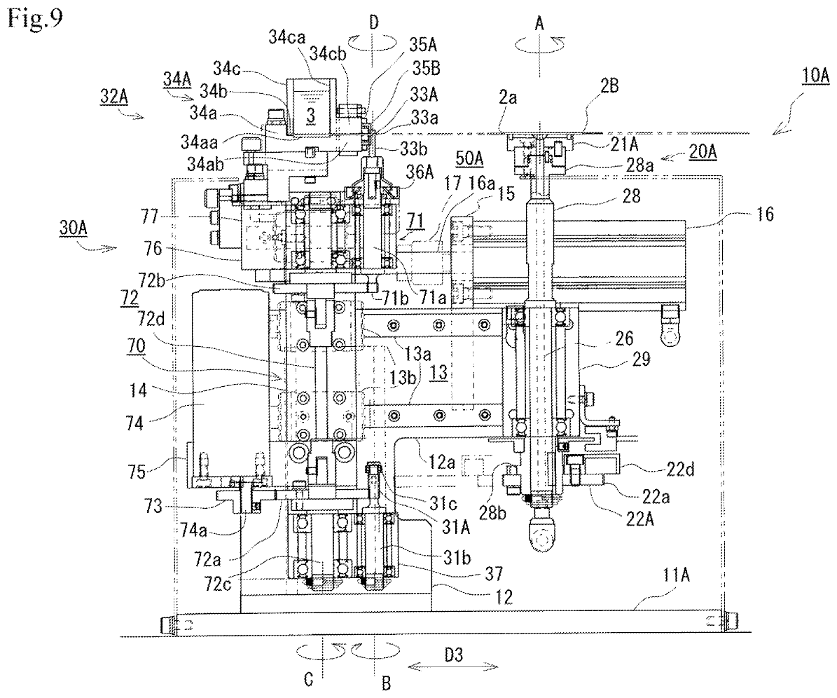

FIG. 9 is a cross-sectional view showing an essential part of the IX-IX line in FIG. 8;

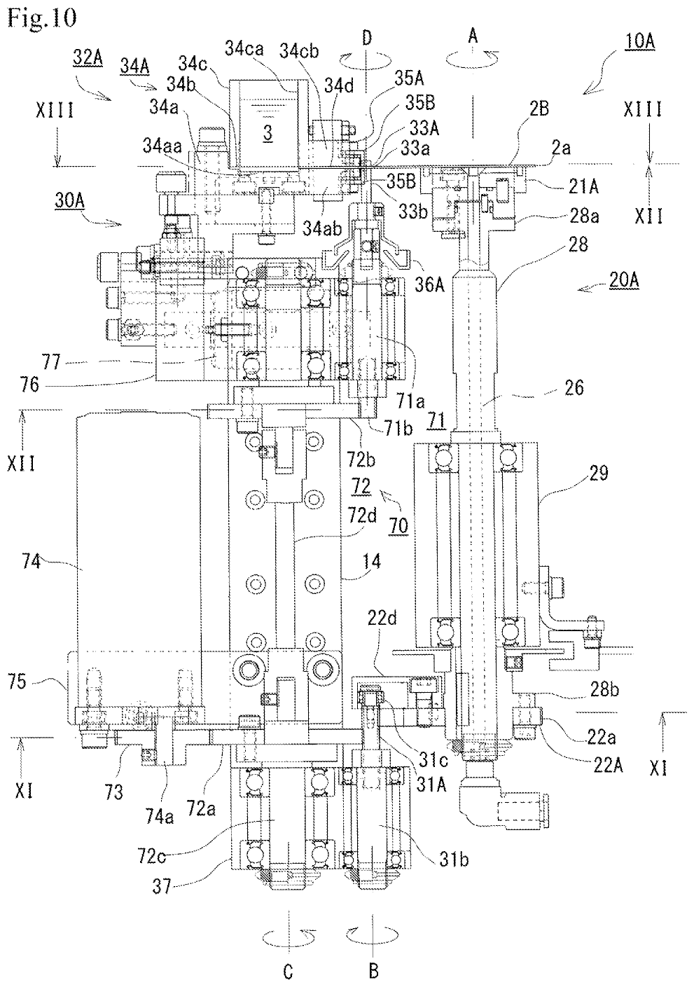

FIG. 10 is a cross-sectional view showing an essential part during the coating operation of the IX-IX line;

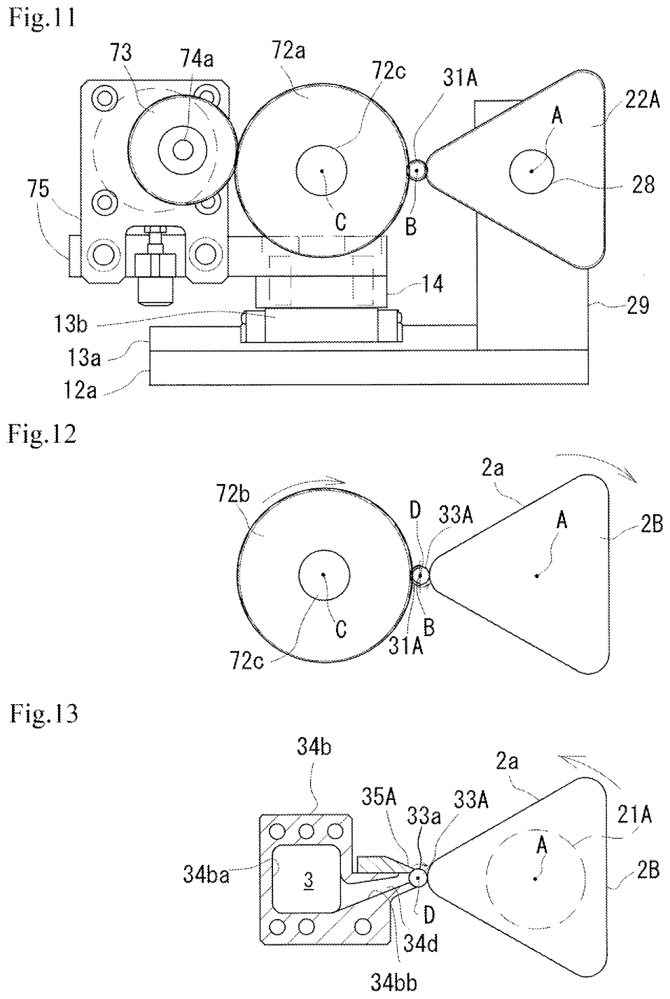

FIG. 11 is a cross-sectional view showing an essential part of the XI-XI line in FIG. 10;

FIG. 12 is a cross-sectional view showing an essential part of the XII-XII line in FIG. 10; and

FIG. 13 is a cross-sectional view showing an essential part of the XIII-XIII line in FIG. 10.

In FIGS. 9-13, hatching showing cross sections is omitted for convenience of illustration.

In FIG. 8, the workpiece is omitted.

Components having the same functions as the coating apparatus 10 shown in FIGS. 1-3 are marked with the same symbols, and their descriptions are omitted here.

A coating apparatus 10A is a apparatus that allows the film-forming liquid 3 to be applied to the outer circumferential edge face 2a in the workpiece 2B (FIGS. 9, 10, 12, and 13) with precision only to the outer circumferential edge face 2a.

The coating apparatus 10A has the rotating mechanism 20A that rotates the workpiece 2B and a coating mechanism 30A that applies the film-forming liquid 3 to the outer circumferential edge face 2a of the workpiece 2B rotated by 20A.

As shown in FIGS. 9 and 10, the rotating mechanism 20A consists of the workpiece 2B and a imitating form 22A, which has an outline identical to that of the workpiece 2B, and can rotate synchronously around the same rotation axis (A axis).

The rotating mechanism 20A has a holding part 21A, a third rotating shaft 28, and a housing 29 that hold the workpiece 2B, and the housing 29 has a bearing, such as a ball bearing, that supports the third rotating shaft 28 in a rotatable manner.

As shown in FIGS. 9 and 10, the coating mechanism 30A consists of a pressing roller 31A, the coating part 32A including the coating roller 33A, and a rotary transmission unit 70 (FIGS. 9 and 10). The coating mechanism 30A further comprises the imitating position adjustment mechanism 50A (FIGS. 8 and 9) and the coating roller pressing part 60A (FIG. 8).

As shown in FIGS. 8 and 9, a cantilevered form bracket (support member) 12 is fixed on the support base 11A of the coating apparatus 10A.

The rotating mechanism 20A is attached to one side of the one end side (tip side) of an arm 12a of the bracket 12.

The coating mechanism 30A is attached to one side of the other end side of the arm 12a of the bracket 12 through a first sliding part 13 and a first attaching board 14, which has a vertical rectangular shape.

The first sliding part 13 allows the coating mechanism 30A to move back and forth in the direction of extension (horizontal direction) of the arm 12a, and consists of a linear guide mechanism including, for example, a linear guide 13a and a slider 13b. the first attaching board 14 is attached to the slider 13b, and the coating mechanism 30A is attached to the first attaching board 14.

A second attaching board 15 is attached to the other side of one end side of the arm 12a and an air cylinder 16 is attached to the second attaching board 15.

A rod 16a of the air cylinder 16 can move back and forth horizontally toward the other end side of the arm 12a.

The air cylinder 16 is designed to be pressure regulated by a control unit, not shown, to control the advancing and retreating movement of the rod 16a.

The tip of the rod 16a of the air cylinder 16 is attached to one end of a L-type Connection tool 18 via a joint 17. It is preferable to use a floating joint for the joint 17 that can absorb eccentricity and angular misalignment.

The other end of the L-type Connection tool 18 is attached to the first attaching board 14. The above configuration allows the coating mechanism 30A attached to the first attaching board 14 to move back and forth horizontally along the linear guide 13a by controlling the reciprocating motion of the rod 16a of the air cylinder 16.

Thus, according to the coating apparatus 10A in the second embodiment, the imitating position adjustment mechanism 50A is composed of the air cylinder 16 and the first sliding part 13.

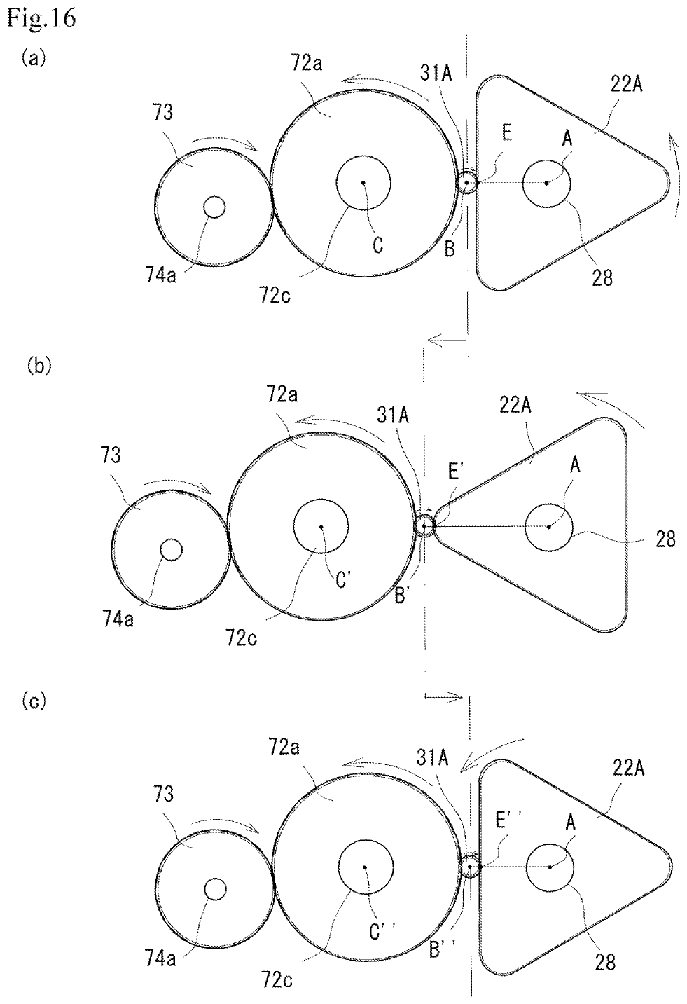

The imitating position adjustment mechanism 50A is a mechanism that allows the position of the coating mechanism 30A, including the pressing roller 31A, to be adjusted to the third direction D3 (FIG. 8) to follow the outer circumferential edge face 22a of the imitating form 22A, while synchronizing the change from the center of rotation (A-axis) of the imitating form 22A to the contact point E (FIG. 16) between the imitating form 22A and the pressing roller 31A, as the imitating form 22A rotates.

the first sliding part 13 is an example of a moving mechanism and the air cylinder 16 is an example of a pressure adjustment unit.

The first sliding part 13 is a mechanism that allows the first attaching board 14, to which the pressing roller 31A, the coating part 32A, and the rotary transmission unit 70 are movably attached, to move D3 along a line connecting the center of rotation (A axis) of the imitating form 22A and the center of rotation (B axis) of the pressing roller 31A (FIGS. 9 and 10).

Since the pressure adjustment section is composed of the air cylinder 16, it is configured to easily absorb or relax the force when pressing the pressing roller 31A to follow the outer circumferential edge face 22a of the imitating form 22A in response to changes in the distance between the A and B axes as the imitating form 22A is rotated. This makes it possible to perform the operation of pressing the pressing roller 31A to follow the outer circumference shape of the imitating form 22A more smoothly.

The third rotating shaft 28, which constitutes the rotating mechanism 20A, has a holding part attachment 28a on one end to which the holding part 21A can be attached and a imitating form attachment part 28b on the other end to which the imitating form 22A can be attached, as shown in FIGS. 9 and 10.

The suction path 26 is formed on the holding part 21A and the third rotating shaft 28 to hold the workpiece 2B in the holding part 21A for suction, and a vacuum device such as a vacuum pump or ejector, not shown, is connected to the lower end of the third rotating shaft 28 via a pipe coupling or the like to enable suction operation.

Therefore, the holding part 21A functions as a table for suction-holding the workpiece 2B, and suction grooves are formed radially on its top surface.

The configuration is such that the workpiece 2B is precisely positioned and placed on the top surface of the holding part 21A in an orientation that overlaps the imitating form 22A in plan view using an industrial robot such as a handling robot, which is not shown in the figure.

As shown in FIGS. 9 and 10, the imitating form 22A is configured to be detachable from the imitating form attachment part 28b, and a hole is formed in the center of rotation of the imitating form 22A into which the third rotating shaft 28 is inserted. The imitating form 22A is made of a metal or other material molded into an approximate identical shape to the outer shape of the workpiece 2B.

The outer circumference of the imitating form 22A has minute tooth profiles that mesh with the minute tooth profiles formed on the outer circumference of the pressing roller 31A, which will be described later, and the outer shape connecting the pitch points of these tooth profiles is designed to be the same shape as the outer shape of the workpiece 2B.

In addition, a pressing roller guide 22d is attached to the imitating form 22A to guide the pressing roller 31A along the curved portion of its circumference.

As shown in FIGS. 9 and 10, the pressing roller 31A, which constitutes the coating mechanism 30A, is configured to be rotatable (rotatable in the companion direction) with the imitating form 22A while pressed against the outer circumferential edge face 22a of the imitating form 22A, and is integrated with a roller shaft 31b to rotate about the B axis center.

The outer surface of the pressing roller 31A has a micro tooth profile that meshes with the micro tooth profile formed on the outer surface of the imitating form 22A, and the pressing roller 31A functions as a small diameter gear.

The pressing roller 31A and the roller shaft 31b are made of metal, for example, but may be made of other hard materials.

As shown in FIGS. 9 and 10, a housing 37 is attached to the lower end of the first attaching board 14, and the roller shaft 31b is rotatably attached to a bearing in the housing 37.

A smaller diameter bearing 31c is also attached to the upper end of the pressing roller 31A. the smaller diameter bearing 31c is for passing the pressing roller guide 22d of the imitating form 22A and has an outer diameter slightly larger than that of the pressing roller 31A.

As shown in FIGS. 9 and 10, the coating roller 33A is for applying the film-forming liquid 3 to the outer circumferential edge face the outer circumferential edge face 2a of the workpiece 2B while being pressed against the outer circumferential edge face 2a of the workpiece 2B and rotating in the companion direction with the workpiece 2B, and is integrated with a roller shaft 33b.

The thickness of the outer circumferential edge face 33a of the coating roller 33A is designed to be less than or equal to the thickness of the outer circumferential edge face 2a of the workpiece 2B, more preferably less than the thickness of the outer circumferential edge face 2a.

The workpiece 2B has a thin shape and the thickness of 2A is, for example, between 0.2 mm and 1 mm. The workpiece 2B may have a thickness of 1 mm or more. The coating roller 33A and the roller shaft 33b are made of metal, for example, but may be made of other hard materials.

The coating roller 33A and the pressing roller 31A have approximately the same diameter, more specifically, the pitch circle (reference circle) of the coating roller 33A and the pressing roller 31A have the same diameter.

The radius of the pressing roller 31A is preferably set below the minimum radius of curvature among the curved portions of the outer circumference of the imitating form 22A.

Since the pressing roller 31A and the coating roller 33A have the same diameter, the radius of the coating roller 33A is also set below the smallest radius of curvature among the curved portions of the outer circumference of the workpiece 2B.

According to this configuration, even if the imitating form 22A has a complicated shape with curved portions with different degrees of curvature, the pressing roller 31A can be accurately followed around the entire circumference of the outer circumferential edge face 22a of the imitating form 22A.

Since the pressing roller 31A and the coating roller 33A have the same diameter and the imitating form 22A and the workpiece 2B have the same shape, it is possible to precisely apply the film-forming liquid 3 to the entire circumference of the outer circumferential edge face 2a of the workpiece 2B by the coating roller 33A even if the workpiece 2B has a complicated shape with curved portions with different bends.

As shown in FIGS. 9 and 10, the rotary transmission unit 70 is equipped with a mechanism for synchronous rotation of the pressing roller 31A and the coating roller 33A (in this case, rotation in the same direction and at the same rotational speed). The rotary transmission unit 70 comprises the fourth transmission unit 71 and the fifth transmission unit 72.

The fourth transmission unit 71 is composed of a rotary transmission shaft 71a, which has the same axis of rotation as the roller shaft 33b of the coating roller 33A, and the fifth gear 71b, which is integrally provided at the lower end (one end) of the rotary transmission shaft 71a, enabling synchronous rotation of the fifth gear 71b and the coating roller 33A at the same axis of rotation center.

At the upper end of the first attaching board 14, a housing 76 is attached via the second sliding part 77 that can slide horizontally. The rotary transmission shaft 71a is rotatably mounted on a bearing in the housing 76, and the roller shaft 33b can be mounted on its upper end (other end).

The fifth gear 71b has a minute tooth profile that meshes with the minute tooth profile formed on the outer circumference of the seventh gear 72b, which will be described later, and the fifth gear 71b functions as a small diameter gear.

The fifth gear 71b has the same diameter as the coating roller 33A, more specifically, the pitch circle (reference circle) of the coating roller 33A and the fifth gear 71b have the same diameter.

The fifth transmission unit 72 is located between the housing 37 and the housing 76 and is equipped with a mechanism to rotate the pressing roller 31A and the fifth gear 71b synchronously (in this case, in the same rotational direction and at the same rotational speed).

The fifth transmission unit 72 comprises the sixth gear 72a, the seventh gear 72b, and a rotary transmission shaft 72c.

The sixth gear 72a is arranged to be rotatable (rotatable in the companion direction) together with the pressing roller 31A.

The outer circumference of the sixth gear 72a has minute tooth profiles that mesh with the minute tooth profiles formed on the outer circumference of the pressing roller 31A, and the sixth gear 72a functions as a large-diameter gearwheel.

The seventh gear 72b has the same diameter as the sixth gear 72a, i.e., the same pitch circle (reference circle) diameter, and is arranged to be rotatable (rotatable in the companion direction) together with the fifth gear 71b.

The outer circumference of the seventh gear 72b has minute tooth profiles that mesh with the minute tooth profiles formed on the outer circumference of the fifth gear 71b, and the seventh gear 72b functions as a large-diameter gearwheel.

The sixth gear 72a and the seventh gear 72b are connected by the rotary transmission shaft 72c for synchronous rotation. The rotary transmission shaft 72c consists of a deflectable shaft 72d that absorbs the shaft eccentricity. Instead of this the deflectable shaft 72d, it may be composed of a shaft part including a universal joint.

The lower end (one end) of the rotary transmission shaft 72c is rotatably mounted on a bearing provided in the housing 37, and its upper end (the other end) is rotatably mounted on a bearing provided in the housing 76.

The rotary transmission unit 70 has the eighth gear 73, which is rotatable (rotatable in the companion direction) together with the sixth gear 72a, and a driving motor 74, which drives the eighth gear 73 to rotate. The driving motor 74 is attached to a motor attaching board 75, and a rotating shaft 74a of the driving motor 74 is attached to the eighth gear 73. The driving motor 74 is composed of a high-precision rotary motor, such as a servo motor, for example.

The outer surface of the eighth gear 73 has a micro tooth profile that meshes with the micro tooth profile formed on the outer surface of the sixth gear 72a.

When the rotating shaft 74a of the driving motor 74 is driven to rotate, the eighth gear 73 rotates and its rotational force is transmitted to the pressing roller 31A via the sixth gear 72a, causing the pressing roller 31A to rotate. At the same time, the rotational force of the eighth gear 73 is transmitted to the fifth gear 71b via the sixth gear 72a, the rotary transmission shaft 72c, and the seventh gear 72b, causing the fifth gear 71b and the coating roller 33A to rotate synchronously.

Thus, the rotary transmission unit 70 is configured to rotate the pressing roller 31A and the coating roller 33A synchronously.

The rotational force of the pressing roller 31A is transmitted to the imitating form 22A and the third rotating shaft 28, causing the imitating form 22A and the workpiece 2B to rotate synchronously. Then, the film-forming liquid 3 is applied to the outer circumferential edge face 2a of the workpiece 2B by the coating roller 33A, which rotates synchronously with the pressing roller 31A.

The micro tooth shapes formed on the outer surface of the eighth gear 73, the sixth gear 72a, the pressing roller 31A, the seventh gear 72b, and the fifth gear 71b are of the same shape. The shape of these tooth profiles is, for example, a concave tooth, the module is, for example, 0.1 to 0.8, preferably 0.2 to 0.4, and the pressure angle is, for example, but not limited to, 20 degrees.

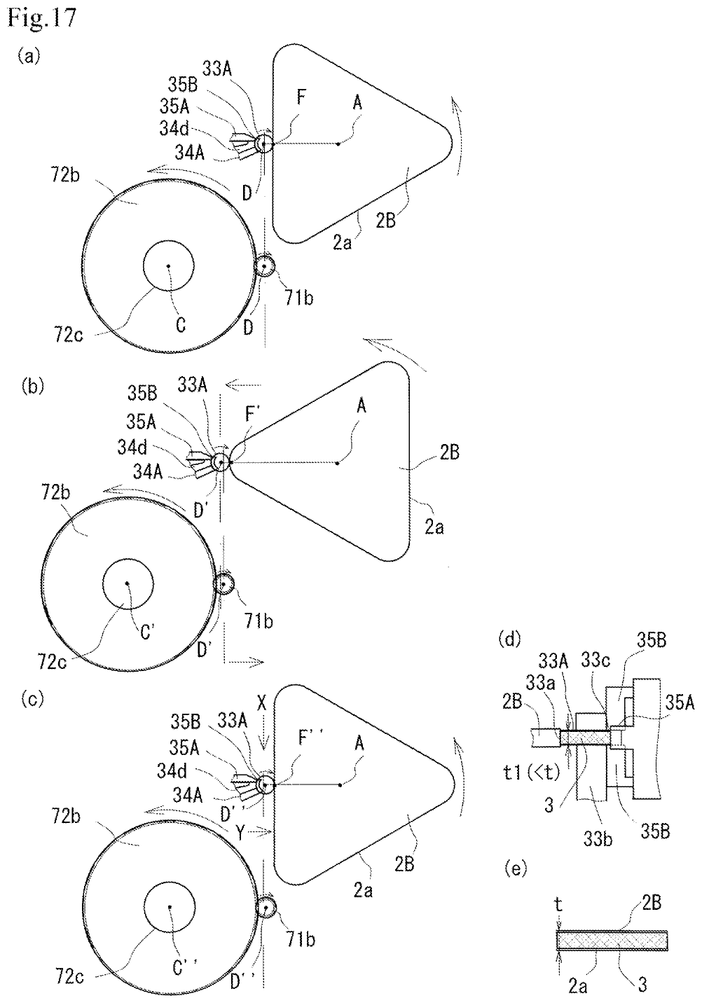

As shown in FIGS. 9 and 10, the coating part 32A comprises the liquid supply section 34A, which supplies the film-forming liquid 3 to the outer circumferential edge face 33a of the coating roller 33A, a bar coater 35A, which is arranged to be in contact with the outer circumferential edge face 33a of the coating roller 33A, and a squeegee 35B, which is arranged to be in contact with a outer circumferential edge part 33c (FIG. 17) of the coating roller 33A.

The roller shaft 33b is provided with a the liquid receiver 36A that receives the extra film-forming liquid 3 that drips from the coating roller 33A.

The liquid supply section 34A consists of a coating base part 34a, which is located above the housing 76, a spacer 34b, which is located above the coating base part 34a, and a coating block 34c, which is located above the spacer 34b.

The coating base part 34a has a rounded corner rectangle on its top surface, a liquid reserve part 34aa, and a tapered shape part 34ab.

The tip of the tapered shape part 34ab is formed in the same arc as the outer circumferential edge face 33a of the coating roller 33A.

The spacer 34b is formed of a thin plate less than the thickness of the coating roller 33A. As shown in FIG. 13, a hole 34ba has the same shape as the liquid reserve part 34aa in the center and a slit hole 34bb has a tapered shape extending from the hole 34ba. The tip of the slit hole 34bb is formed in an arc shape that can contact the outer circumferential edge face 33a of the coating roller 33A.

The coating block 34c has a tube part 34ca, which has the same shape as the liquid reserve part 34aa, and a tapered shape part 34cb in the center.

The tapered shape part 34cb of the coating block 34c and the tapered shape part 34ab of the coating base part 34a are identical in shape, and the spacer 34b is interposed between the coating base part 34a and the coating block 34c to form a liquid channel 34d (FIGS. 10 and 13) in the slit hole 34bb part.

As shown in FIG. 13, the bar coater 35A is placed at the tip opening of the liquid channel 34d of the liquid supply section 34A.

The tip surface of the bar coater 35A, i.e., the surface to be in contact with the outer circumferential edge face 33a of the coating roller 33A, has a plurality of microgrooves along the direction of rotation of the coating roller 33A.

The groove spacing of the micro grooves is designed to be, for example, 0.05 mm to 0.2 mm, more preferably around 0.1 mm. The bar coater 35A is an example of a liquid stretching part, as it is used to scrape off excess film-forming liquid 3 of the film-forming liquid 3 applied to 3a of the coating roller 33A while stretching it into a thin film.

In addition, the squeegee 35B is placed at the tip of each of the coating base part 34a's the tapered shape part 34ab and the coating block 34c's the tapered shape part 34cb.

As shown in FIG. 17, each the squeegee 35B is formed in the same arc shape as the circumference of the coating roller 33A, and its tip is in a form that enables it to contact the outer circumferential edge part 33c on the upper and lower surfaces of the coating roller 33A.

In other words, it is in the form of two the squeegee 35B sandwiching the outer edge of the coating roller 33A.

The squeegee 35B are used to scrape off the film-forming liquid 3 adhered to the outer circumferential edge part 33c of the coating roller 33A and are an example of a liquid scraping part.

As shown in FIG. 8, 77 is located between the housing 76, to which the coating part 32A is attached, and the first attaching board 14.

Also, the elastic member 61A and an attaching member 62A, to which one end of the elastic member 61A is attached, are placed between the housing 76 and the first attaching board 14.

The elastic member 61A is positioned with variable force along a line connecting the center of rotation of the workpiece 2B (axis A) and the center of rotation of the coating roller 33A (axis D) at the fourth direction D4 (FIG. 8).

The coating roller pressing part 60A is comprised of the elastic member 61A and the attaching member 62A.

The coating roller pressing part 60A allows fine adjustment of the force pressing the coating roller 33A onto the outer circumferential edge face 2a of the workpiece 2B.

The operation of applying the film-forming liquid 3 to the outer circumferential edge face 2a of the workpiece 2B using the coating apparatus 10A according to the second embodiment is described next.

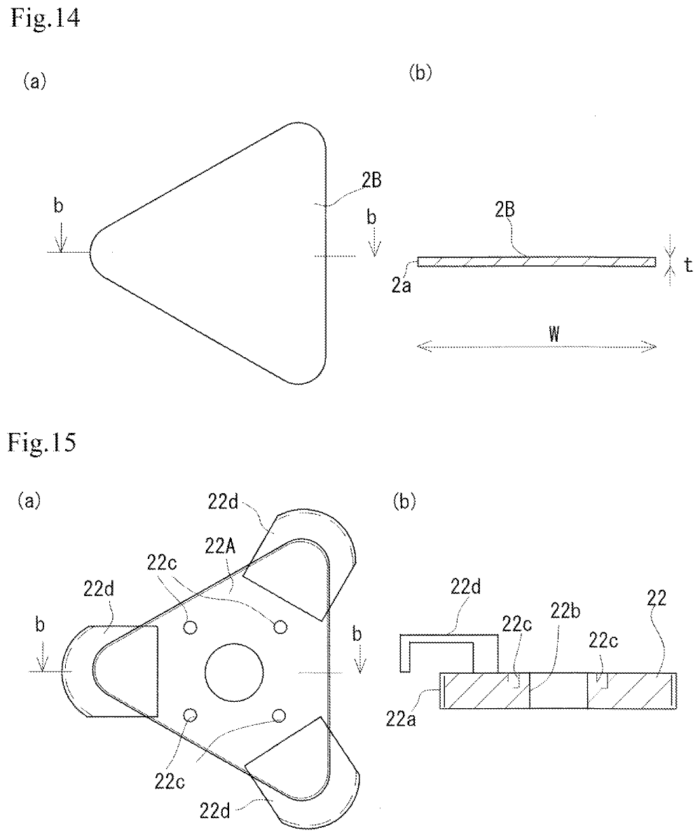

FIG. 14 is a figure showing an example of a workpiece, (a) is a plan view and (b) is a b-b cross section in (a).

The workpiece 2B is a lens for smart glasses, for example, a non-circular lens with a width and height of about the rotary transmission unit 40 to 60 mm and a thickness t of the outer circumferential edge face 2a of about 0.2 to 1 mm.

The shape of the workpiece 2B is, in this case, a rounded triangular shape with a curved section with a large curvature (curved corner).

The shape of the workpiece 2B is not limited to this, and may be a rounded-angle inverted trapezoidal shape, a rounded-angle rectangular shape, a rounded-angle convex shape, or any other oval shape.

FIG. 15 is a figure showing an example of a imitating form, (a) is a plan view and (b) is a b-b cross section in (a).

The imitating form 22A has a shape identical to the outline of the workpiece 2B. In the center portion of the imitating form 22A, the insertion hole 22b is formed for insertion and attachment to the third rotating shaft 28 of the rotating mechanism 20A. In the peripheral portion of the insertion hole 22b, the attachment hole 22c, a bolt or other fixture, is formed, and the imitating form 22A can be attached to and detached from the imitating form attachment part 28b using the fixture. In addition, the pressing roller guide 22d is attached to the rounded corner of the imitating form 22A.

The imitating form 22A is prepared for each type (shape) of the workpiece 2B.

The imitating form 22A has tooth profiles formed on its outer circumference so that it can mesh with the tooth profiles formed on the outer circumference of the pressing roller 31A and can rotate in a companion manner.

The shape of these tooth profiles is the same as the tooth profile formed on the pressing roller 31A, e.g., coarse teeth, and the module is, for example, 0.1 to 0.8, preferably 0.2 to 0.4, and the pressure angle is, for example, 20 degrees, but not limited to this.

The imitating form 22A is preferably molded from a metal member, but may also be molded from other hard materials.

First, in starting the coating operation, the workpiece 2B is installed in the holding part 21A of the coating apparatus 10A.

The workpiece 2B is installed on the top surface of the holding part 21A by a handling robot, for example, and is held in a suctioned state on the holding part 21A.

At this time, the workpiece 2B is installed in the holding part 21A so that the center of rotation of the workpiece 2B is aligned with the center of rotation of the imitating form 22A (center of rotation (A axis) of the third rotating shaft 28) and the orientation of the workpiece 2B is aligned with the orientation of the imitating form 22A (so that the entire periphery of the workpiece 2B and the imitating form 22A overlap in plan view).

When attaching and detaching the workpiece 2B, it is possible to drive the air cylinder 16 of the imitating position adjustment mechanism 50A to move the coating mechanism 30A out of position so that the imitating form 22A and the pressing roller 31A are a predetermined distance apart, as shown in FIGS. 8 and 9.

Once the workpiece 2B is in place on the top surface of the holding part 21A, the air cylinder 16 comprising the imitating position adjustment mechanism 50A is then driven to move the coating mechanism 30A so that the pressing roller 31A is pressed against the imitating form 22A.

When the pressing roller 31A is pressed against the imitating form 22A, the driving motor 74 of the coating mechanism 30A is then driven, and the eighth gear 73 begins to rotate at a predetermined speed by the rotational driving force of the driving motor 74.

In turn, the sixth gear 72a, which is engaged with the eighth gear 73, rotates in the companion direction, and the pressing roller 31A, which is also engaged with the sixth gear 72a, begins to rotate in the companion direction.

When the sixth gear 72a rotates, the seventh gear 72b connected via the sixth gear 72a and the rotary transmission shaft 72c rotates in the same direction as the sixth gear 72a, synchronized with the rotation of the sixth gear 72a. Furthermore, the fifth gear 71b, which is engaged with the seventh gear 72b, begins to rotate in the companion direction.

Then, the coating roller 33A connected via the fifth gear 71b and the rotary transmission shaft 71a begins to rotate in the same direction as the fifth gear 71b.

The transmission of the rotational driving force from the driving motor 74 causes the pressing roller 31A and the coating roller 33A to rotate synchronously.

When the pressing roller 31A and the coating roller 33A begin to rotate, the imitating form 22A with its tooth profile meshing with the pressing roller 31A and each other begins to rotate in the companion direction, and the workpiece 2B held by the holding part 21A through the third rotating shaft 28 rotates in synchronization with that rotation.

As the coating roller 33A rotates, the film-forming liquid 3 begins to be supplied from the liquid supply section 34A of the coating part 32A to the outer circumferential edge face 33a of the coating roller 33A. The supplied film-forming liquid 3 is scraped off the excess film-forming liquid 3 by the bar coater 35A and the squeegee 35B, and the film-forming liquid 3 is applied (adhered) in a line only to the outer circumferential edge face 33a of the coating roller 33A.

The film-forming liquid 3 applied to the outer circumferential edge face 33a of the coating roller 33A is then applied (transferred) to the outer circumferential edge face 2a of the workpiece 2B, which is rotating in the companion direction while being pressed against the outer circumferential edge face 33a of the coating roller 33A.

FIG. 16 is a schematic diagram illustrating the operation of the imitating form 22A, the pressing roller 31A, the sixth gear 72a, and the eighth gear 73 during the coating operation by the coating apparatus 10A.

FIG. 16(a) shows a scene with the pressing roller 31A pressed against the imitating form 22A, the eighth gear 73 rotating to the right due to rotational power from the driving motor 74, the sixth gear 72a rotating in companion (left) rotation following the rotation of the eighth gear 73, the pressing roller 31A rotating in companion (right) rotation following the rotation of the sixth gear 72a, and the imitating form 22A rotating in companion (left) rotation following the rotation of the pressing roller 31A.

FIG. 16(b) shows the state of the imitating form 22A when it is rotated approximately 60 degrees to the left from the state shown in FIG. 16(a).

The pressing roller guide 22d (FIG. 15) is positioned above the pressing roller 31A (above the smaller diameter bearing 31c (FIG. 10)), and the structure is such that the position of the pressing roller 31A at the curved corner of the imitating form 22A is regulated (preventing misalignment) by the pressing roller guide 22d.

As the imitating form 22A rotates left and the curved corner of the imitating form 22A approaches the pressing roller 31A, a leftward pressure force is exerted on the pressing roller 31A from the imitating form 22A, and the imitating position adjustment mechanism 50A (FIGS. 8 and 9) moves the pressing roller 31A, the sixth gear 72a, and the eighth gear 73 (i.e., the coating mechanism 30A) to the left for copying position adjustment.

FIG. 16(c) shows the state of the imitating form 22A when it is rotated another 60 degrees to the left from the state in FIG. 16(b).

As the imitating form 22A further rotates to the left and the curved corner of the imitating form 22A moves away from the pressing roller 31A, the imitating position adjustment mechanism 50A (FIGS. 8 and 9) exerts a rightward pressure on the imitating form 22A from the pressing roller 31A, causing the pressing roller 31A, the sixth gear 72a, and the eighth gear 73 (i.e., the coating mechanism 30A) to move to the right, resulting in copying position adjustment.

The direction of rotation indicated by the arrow in FIG. 16 is an example, and it is also possible to configure the system to rotate in the opposite direction to that of the arrow shown in the figure.

FIG. 17 is a schematic diagram to illustrate the operation of the workpiece 2B and the coating roller 33A, the fifth gear 71b, the seventh gear 72b during the coating operation by the coating apparatus 10A.

FIG. 17(a) shows the same timing state as that shown in FIG. 16(a), and similarly, FIG. 17(b) shows the same timing state as that shown in FIG. 16(b), and FIG. 17(c) shows the same timing state as that shown in FIG. 16(c).

FIG. 17(a) shows a scene in which the film-forming liquid 3 is being applied to the outer circumferential edge face 2a of the workpiece 2B with the coating roller 33A pressed against the workpiece 2B.

That is, the seventh gear 72b rotates in the same direction (left rotation) as the sixth gear 72a connected via the rotary transmission shaft 72c, the fifth gear 71b rotates in a companion rotation (right rotation) following the rotation of the seventh gear 72b, and the coating roller 33A connected to the fifth gear 71b via the rotary transmission shaft 71a rotates in the same direction (right rotation) as the fifth gear 71b while applying the film-forming liquid 3 to the outer circumferential edge face 2a of the workpiece 2B.

FIG. 17(b) shows the state of the workpiece 2B when it rotates 60 degrees to the left from the state shown in FIG. 17(a).

As the workpiece 2B rotates to the left and the curved corner of the workpiece 2B approaches the coating roller 33A, a leftward pressing force is exerted from the workpiece 2B to the coating roller 33A, and the imitating position adjustment mechanism 50A (FIGS. 8 and 9) moves the coating roller 33A, the fifth gear 71b, and the seventh gear 72b (i.e., the coating mechanism 30A) to the left to perform copying position adjustment.

At the same time, the pressing force of the coating part 32A including the coating roller 33A against the workpiece 2B is finely adjusted by the coating roller pressing part 60A (FIG. 8) on the coating part 32A.

FIG. 17(c) shows the state of the workpiece 2B when it is rotated another 60 degrees to the left from the state shown in FIG. 17(b).

As the workpiece 2B rotates further left and the curved corner of the workpiece 2B moves away from the coating roller 33A, the imitating position adjustment mechanism 50A (FIGS. 8 and 9) exerts a rightward pressure force on the workpiece 2B from the coating roller 33A, causing the coating roller 33A, the fifth gear 71b, and the seventh gear 72b (i.e., the coating mechanism 30A) to move to the right, resulting in copying position adjustment. At the same time, the pressing force of the coating part 32A including the coating roller 33A on the workpiece 2B is finely adjusted by the coating roller pressing part 60A (FIG. 8) on the coating part 32A.

FIG. 17(d) shows an enlarged view of the side of the coating roller 33A as seen from the arrow X direction shown in FIG. 17(c), and FIG. 17(e) shows the side of the workpiece 2B as seen from the arrow Y direction shown in FIG. 17(c).

The film-forming liquid 3 applied to the outer circumferential edge face 33a of the coating roller 33A is now only applied to the outer circumferential edge face 2a of the workpiece 2B.

As shown in FIGS. 1 and the joint 17, the pressing roller 31A and the coating roller 33A rotate synchronously with the rotational drive of the driving motor 74 in the coating mechanism 30A.

As shown in FIG. 16, since the imitating form 22A is non-circular, as the imitating form 22A rotates, the distances AE, AE′, AE′, AE″ from the center of rotation (A-axis) of the imitating form 22A to the contact points E, E′, E″ between the imitating form 22A and the pressing roller 31A will change.

In the state shown in FIG. 16(b), the distance AE′ is longer than the distance AE in the state shown in FIG. 16(a). The position of the coating mechanism 30A is then adjusted by the imitating position adjustment mechanism 50A (FIGS. 8 and 9) so that the position of the center of rotation (B axis) of the pressing roller 31A moves from B to B′ in synchronization with the change from distance AE to distance AE′ as the imitating form 22A rotates.

In the state shown in FIG. 16(c), the distance is AE″, and the distance AE″ is shorter than the distance AE′ in the state shown in FIG. 16(b).

Then, synchronizing the change from distance AE′ to distance AE″ with the rotation of the imitating form 22A, the position of the coating mechanism 30A is adjusted by the imitating position adjustment mechanism 50A so that the position of the center of rotation (B axis) of the pressing roller 31A moves from B′ to B″.

Thus, the position of the pressing roller 31A is adjusted by the imitating position adjustment mechanism 50A so that the pressing roller 31A follows the shape of the outer circumferential edge face 22a of the imitating form 22A while synchronizing with the change in the distance AE from the center of rotation (A-axis) of the imitating form 22A to the contact point E between the imitating form 22A and the pressing roller 31A as the imitating form 22A rotates.

The imitating form 22A and the workpiece 2B are arranged so that their centers of rotation are on the same axis (A axis) and their outer circumferences overlap each other in plan view, and the coating mechanism 30A, whose position is adjusted by the imitating position adjustment mechanism 50A, has the pressing roller 31A and the coating roller 33A on the same axis (B axis and D axis).

Therefore, the movement between the workpiece 2B and the coating roller 33A shown in FIG. 17 is basically synchronized with the movement between the imitating form 22A and the pressing roller 31A shown in FIG. 16.

In other words, the position of the coating roller 33A (position of the center of rotation (D axis)) is adjusted by the imitating position adjustment mechanism 50A to follow the outer circumferential edge face 33a of the coating roller 33A, synchronizing with the change in the distance AF from the center of rotation (A axis) of the workpiece 2B to the contact point F of the workpiece 2B and the coating roller 33A as the workpiece 2B rotates.

In addition, in the operation between the workpiece 2B and the coating roller 33A, the force pressing the coating roller 33A onto the outer circumferential edge face 2a of the workpiece 2B is adjustable by the elastic member 61A of the coating roller pressing part 60A (FIG. 8).

In other words, in the coating mechanism 30A, the pressing roller 31A and the coating roller 33A are basically arranged on the same axis (B and D axes), but the coating part 32A, including the coating roller 33A, is arranged in a form that allows sliding in the linear direction connecting the A and D axes by the second sliding part 77, and the rotary transmission shaft 72c has the deflectable shaft 72d (FIGS. 9 and 10).

However, the sliding range (distance) of the coating roller 33A is limited to a very small range (a few mm or less).

Since the coating part 32A is pressed by the elastic member 61A with variable force to the fourth direction D4 (FIG. 8), the pressing force when the coating roller 33A is pressed against the outer circumferential edge face 2a of the workpiece 2B can be relaxed or absorbed by the elastic member 61A.

Therefore, it is possible to apply the film-forming liquid 3 with the coating roller 33A pressed against the outer circumferential edge face 2a of the workpiece 2B with a force weaker than the force with which the pressing roller 31A is pressed against the outer circumferential edge face 22a of the imitating form 22A.

As shown in FIG. 17(d), the film-forming liquid 3 supplied to the outer circumferential edge face 33a of the coating roller 33A will be stretched into a thin film only on the outer circumferential edge face 33a, as the excess film-forming liquid 3 is scraped off by the bar coater 35A and the squeegee 35B.

Since the thickness of the outer circumferential edge face 33a of the coating roller 33A is less than or equal to the thickness t of the workpiece 2B, the coating width t1 of the film-forming liquid 3 is less than or equal to the thickness t of the workpiece 2B. The shape of the micro-groove of the bar coater 35A is designed so that the coating thickness of the film-forming liquid 3 is less than several tens of micrometers, for example, for a light-shielding material.

The outer circumferential edge face 33a portion of the coating roller 33A with the film-forming liquid 3 applied is then pressed against the outer circumferential edge face 2a of the workpiece 2B while rotating, so that the film-forming liquid 3 is transferred and applied to the outer circumferential edge face 2a of the workpiece 2B with a coating width of less than the thickness t of the workpiece 2B and with a predetermined coating thickness.

According to the coating apparatus 10A in the second embodiment, the workpiece 2B and the imitating form 22A, which have the same outline, are configured by the rotating mechanism 20A to rotate synchronously around the same rotating axis (A-axis).

With the pressing roller 31A pressed against the outer circumferential edge face 22a of the imitating form 22A, and with the coating roller 33A pressed against the outer circumferential edge face 2a of the workpiece 2B, by the coating mechanism 30A respectively, the pressing roller 31A and the coating roller 33A can be rotated synchronously by the rotary transmission unit 70.

Therefore, the rotational motion of the imitating form 22A, which rotates together with the pressing roller 31A, can be synchronized with that of the workpiece 2B, which rotates together with the coating roller 33A.

Even if the distance AE (FIG. 16) from the center of rotation (A-axis) of the imitating form 22A to the contact point E between the imitating form 22A and the pressing roller 31A changes as the imitating form 22A, which has a noncircular shape, is rotated, the position of the pressing roller 31A is precisely adjusted, synchronized with the change in distance AE so that the pressing roller 31A rotates with the pressing roller 31A pressed against the outer circumferential edge face 22a of the imitating form 22A, by the imitating position adjustment mechanism 50A.

Synchronized with this action, the position of the coating roller 33A will also be precisely adjusted, synchronized with the change in distance AE, so that the coating roller 33A rotates with the coating roller 33A pressed against the outer circumferential edge face 2a of the workpiece 2B.

Therefore, by providing the imitating form 22A, which has a shape that is almost identical to the outer shape of the workpiece 2B, the film-forming liquid 3 can be precisely applied only to the outer circumferential edge face 2a of the workpiece 2B, i.e., with a coating width less than the thickness of the workpiece 2B, according to the shape of the workpiece 2B (in other words, regardless of the shape of the workpiece 2B).

Even if the workpiece 2B is thin and prone to damage such as cracks and splits, the imitating form 22A limits the pressing force of the coating roller 33A against the outer circumferential edge face 2a of the workpiece 2B, thereby preventing damage to the workpiece 2B.

According to the coating apparatus 10A, the imitating position adjustment mechanism 50A comprises the first sliding part 13 and the air cylinder 16, wherein the first attaching board 14 attached to the coating mechanism 30A is configured by the first sliding part 13 to be movable to the third direction D3.

The air cylinder 16 also allows the first attaching board 14 and the coating mechanism 30A attached to the first sliding part 13 to be pressure-adjustable to the third direction D3.

Therefore, the first attaching board 14 can be moved to the third direction D3 with the pressing roller 31A, the coating part 32A, and the rotary transmission unit 70 integrated and with the pressing roller 31A pressed against the imitating form 22A so that it follows the outer shape of the imitating form 22A.

This prevents misalignment of the axes of rotation (B and D axes) of the pressing roller 31A and the coating roller 33A during the coating operation and enhances the accuracy of the operation of pressing the coating roller 33A against the workpiece 2B so that the coating roller 33A follows the outer circumferential edge face 2a of the workpiece 2B.

According to the coating apparatus 10A, since the coating roller pressing part 60A comprises the elastic member 61A and the second sliding part 77, the elastic member 61A and the second sliding part 77 make it possible to moderately adjust the force pressing the coating roller 33A against the outer circumferential edge face 2a of the workpiece 2B.

For example, it is possible to adjust (relax or absorb) the pressing force of the coating roller 33A against the workpiece 2B so that the pressing force of the coating roller 33A against the workpiece 2B is less than the pressing force of the pressing roller 31A against the imitating form 22A.

Therefore, with the coating roller 33A lightly pressed against the outer circumferential edge face 2a of the workpiece 2B, the film-forming liquid 3 can be precisely applied to the outer circumferential edge face 2a of the workpiece 2B with the desired coating width and thickness. In addition, the effect of preventing damage to the workpiece 2B can be enhanced.

According to the coating apparatus 10A, the fifth transmission unit 72 causes the pressing roller 31A and the fifth gear 71b to rotate synchronously, and the rotation of the fifth gear 71b is transmitted synchronously to the coating roller 33A via the fourth transmission unit 71.

Therefore, the fifth transmission unit 72 and the fourth transmission unit 71 enable synchronized rotation of the pressing roller 31A and the coating roller 33A. Therefore, the synchronization accuracy between the rotational motion of the imitating form 22A, which rotates together with the pressing roller 31A, and that of the workpiece 2B, which rotates together with the coating roller 33A, can be increased. In addition, the spacing between the pressing roller 31A and the coating roller 33A can be adjusted by the fifth transmission unit 72 and the fourth transmission unit 71.

According to the coating apparatus 10A, the synchronized rotation of the sixth gear 72a and the seventh gear 72b via the rotary transmission shaft 72c causes the synchronized rotation of the pressing roller 31A, which is engaged with the sixth gear 72a, and the fifth gear 71b, which is engaged with the seventh gear 72b, and the rotation of the fifth gear 71b is transmitted synchronously to the coating roller 33A via the rotary transmission shaft 71a.

Therefore, it is possible to synchronously rotate the pressing roller 31A and the coating roller 33A with a simple configuration.

According to the coating apparatus 10A, since the rotary transmission shaft 72c is composed of the deflectable shaft 72d, even if there is some misalignment (eccentricity) in the axial direction between the center of rotation of the pressing roller 31A (B axis) and the center of rotation of the coating roller 33A (D axis), it is possible to rotate the pressing roller 31A and the coating roller 33A synchronously with high accuracy while absorbing or mitigating such misalignment.

According to the coating apparatus 10A, by driving the eighth gear 73 rotationally by the driving motor 74, the rotational force of the eighth gear 73 is transmitted to the pressing roller 31A via the sixth gear 72a.

The rotational force of the eighth gear 73 is also transmitted to the fifth gear 71b via the sixth gear 72a, the rotary transmission shaft 72c, and the seventh gear 72b, and then from the fifth gear 71b to the coating roller 33A via the rotary transmission shaft 71a.

Therefore, the rotational drive force of the driving motor 74 is transmitted to the pressing roller 31A and the coating roller 33A, and the pressing roller 31A and the coating roller 33A can be rotated synchronously with high accuracy.

According to the coating apparatus 10A, the outer surface of each of the imitating form 22A, the pressing roller 31A, the sixth gear 72a, the eighth gear 73, the seventh gear 72b, and the fifth gear 71b is formed with minute tooth profiles that can be engaged, thereby reducing deviations in synchronization timing of rotational movements and improving synchronization accuracy.

According to the coating apparatus 10A, since the radius of the pressing roller 31A is set below the minimum radius of curvature among the curved portions (curved corner portions) of the imitating form 22A, even if the imitating form 22A has a shape with multiple curved portions with different curvature, the pressing roller 31A can be accurately imitated with all curved portions of the imitating form 22A pressed against it.

Therefore, with the coating roller 33A, which has the same outline shape as the pressing roller 31A, the film-forming liquid 3 can be precisely applied to the outer circumferential edge face 2a (i.e., having multiple curved sections with different degrees of curvature) of the workpiece 2B, which has the same outline shape as the imitating form 22A.

According to the coating apparatus 10A, by providing the pressing roller guide 22d in the imitating form 22A, even if the curved portion (curved corner, etc.) of the imitating form 22A has a large degree of curvature (small radius of curvature), the pressing roller 31A can be securely guided along the curved portion of the imitating form 22A, with the pressing roller 31A pressed against said curved portion.

As a result, even if the workpiece 2B has a shape with a curved section with a large degree of curvature, the coating roller 33A can accurately apply the film-forming liquid 3 to the outer circumferential edge face 2a of the workpiece 2B.

According to the coating apparatus 10A, since the third rotating shaft 28 is rotatably supported by the housing 29 and the holding part attachment 28a is provided at one end of the third rotating shaft 28 and the imitating form attachment part 28b at the other end, the holding part 21A and the imitating form 22A can be easily attached and detached.

In addition, since the suction path 26 is formed on the third rotating shaft 28 and the holding part 21A, the workpiece 2B can be adsorbed and held on the holding part 21A, and the workpiece 2B can be easily attached and detached.

According to the coating apparatus 10A, the liquid supply section 34A, the bar coater 35A, and the squeegee 35B allow the film-forming liquid 3 to adhere to the outer circumferential edge face 33a of the coating roller 33A without protruding from the outer circumferential edge face 33a, but only to that the outer circumferential edge face 33a while extending.

And since the thickness of the outer circumferential edge face 33a of the coating roller 33A is less than or equal to the thickness of the outer circumferential edge face 2a of the workpiece 2B, the film-forming liquid 3 can be applied while transferring cleanly from the outer circumferential edge face 33a of the coating roller 33A to the outer circumferential edge face 2a of the workpiece 2B.

According to the coating apparatus 10A, the bar coater 35A has a plurality of micro-grooves on its contact surface with the outer circumferential edge face 33a of the coating roller 33A, allowing the film-forming liquid 3 to adhere to the outer circumferential edge face 33a of the coating roller 33A while extending it thinly and evenly, the film-forming liquid 3 can be applied uniformly from the coating roller 33A to the outer circumferential edge face 2a of the workpiece 2B, which has a thin plate shape.

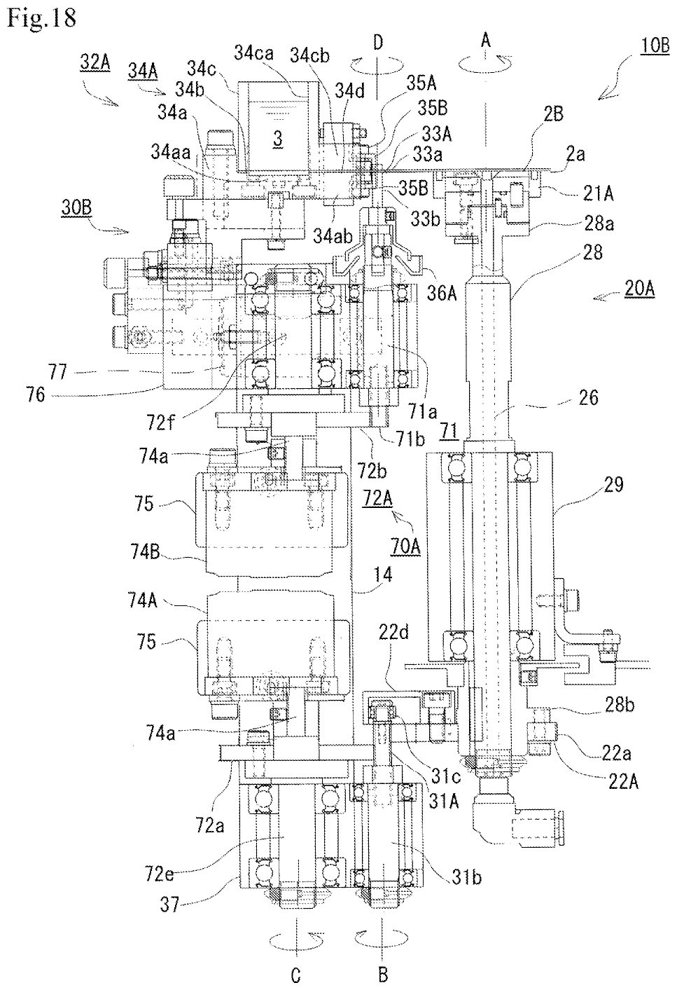

FIG. 18 is a cross-sectional view showing an essential part configuration of the coating apparatus 10B according to another embodiment of the present invention.

In FIG. 18, hatching indicating the cross section is omitted for convenience of illustration. Components having the same functions as those of the coating apparatus 10A shown in FIGS. 8-10 are marked with the same symbols, and their descriptions are omitted here.

The configuration in which the coating apparatus 10B differs from the coating apparatus 10A described above is the configuration of a rotary transmission unit 70A comprising a coating mechanism 30B.

In the coating apparatus 10B, the fifth transmission unit 72A comprising the rotary transmission unit 70A has the sixth gear 72a that can rotate together with the pressing roller 31A, the seventh gear 72b that has the same outline as the sixth gear 72a and can rotate together with the fifth gear 71b, the first driving motor 74A that drives the sixth gear 72a, and the second driving motor 74B that drives the seventh gear 72b.

The sixth gear 72a is attached to 72e, which is rotatably supported on a shaft at the housing 37. The seventh gear 72b is attached to the seventh gear shaft 72f, which is rotatably supported on a shaft at the housing 76.

Two upper and lower motor attaching board 75 are attached to the first attaching board 14, the first driving motor 74A to the lower motor attaching board 75 and the second driving motor 74B to the upper motor attaching board 75.

In the coating apparatus 10B, unlike the coating apparatus 10A, without the rotary transmission shaft 72c connecting the sixth gear 72a and the seventh gear 72b, the rotational speeds of the first driving motor 74A and the second driving motor 74B are synchronously controlled to synchronize the rotation of the sixth gear 72a and the seventh gear 72b.

According to the coating apparatus 10B, the rotational drive force of the first driving motor 74A is transmitted to the pressing roller 31A via the sixth gear 72a, the rotational drive force of the second driving motor 74B is transmitted to the fifth gear 71b via the seventh gear 72b and the rotation of the fifth gear 71b is synchronously transmitted to the coating roller 33A by the fourth transmission unit 71.

Therefore, the pressing roller 31A and the coating roller 33A can be rotated precisely and synchronously by the configuration that synchronises the rotational drive of the first driving motor 74A and the second driving motor 74B.

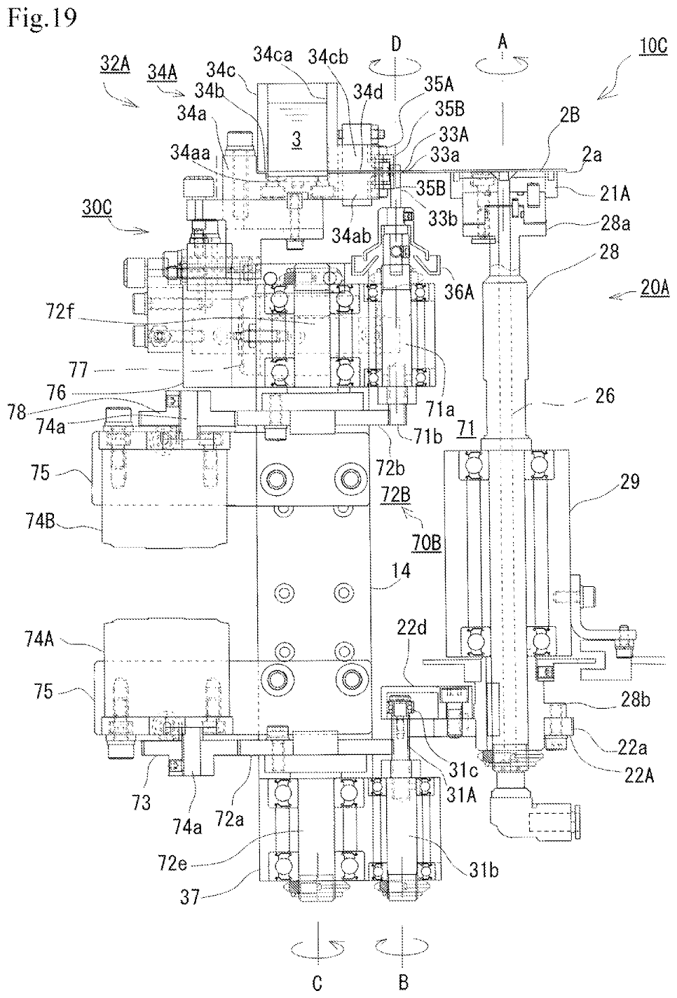

FIG. 19 is a cross-sectional view showing an essential part configuration of the coating apparatus 10C according to another embodiment of the present invention.

In FIG. 19, hatching indicating the cross section is omitted for convenience of illustration. Components having the same functions as those of the coating apparatus 10A shown in FIGS. 8-10 are marked with the same symbols, and their descriptions are omitted here.

The configuration in which the coating apparatus 10C differs from the coating apparatus 10A described above is the configuration of the rotary transmission unit 70B comprising a coating mechanism 30C.

In the coating apparatus 10C, the fifth transmission unit 72B comprising the rotary transmission unit 70B has the sixth gear 72a that can rotate together with the pressing roller 31A, the seventh gear 72b that has the same outline as the sixth gear 72a and can rotate together with the fifth gear 71b, the eighth gear 73 that can rotate together with the sixth gear 72a, the first driving motor 74A that drives the eighth gear 73, the ninth gear 78 that can rotate together with the seventh gear 72b, and the second driving motor 74B that drives the ninth gear 78.

The sixth gear 72a is attached to 72e, which is rotatably supported on a shaft at the housing 37. The seventh gear 72b is attached to the seventh gear shaft 72f, which is rotatably supported on a shaft at the housing 76.

Two upper and lower motor attaching board 75 are attached to the first attaching board 14, the first driving motor 74A to the lower motor attaching board 75 and the second driving motor 74B to the upper motor attaching board 75.

In the coating apparatus 10C, unlike the coating apparatus 10A, without the rotary transmission shaft 72c connecting the sixth gear 72a and the seventh gear 72b, the rotational speeds of the rotating shaft 74a of the first driving motor 74A and the rotating shaft 74a of the second driving motor 74B are synchronously controlled to synchronise the rotation of 83 and 72A, and the ninth gear 78 and the fifth transmission unit 72B.

According to the coating apparatus 10C, the rotational drive of the first driving motor 74A is transmitted to the pressing roller 31A via the eighth gear 73 and the sixth gear 72a, the rotational drive of the second driving motor 74B is transmitted to the fifth gear 71b via the ninth gear 78 and the seventh gear 72b, and the rotation of the fifth gear 71b is synchronously transmitted to the coating roller 33A by the fourth transmission unit 71.

Therefore, the pressing roller 31A and the coating roller 33A can be rotated precisely and synchronously by the configuration that synchronizes the rotational drive of the first driving motor 74A and the second driving motor 74B.

In yet another embodiment of coating apparatus, the roller shaft 31b or the pressing roller 31A may be driven rotationally by the first driving motor 74A and the rotary transmission shaft 71a or the fifth gear 71b of the fourth transmission unit 71 may be driven rotationally by the second driving motor 74B to synchronise the pressing roller 31A and the coating roller 33A.

### INDUSTRIAL APPLICABILITY

The invention has a wide range of applications in the electronics industry and other fields dealing with thin lenses used in smart glasses, AR or VR goggles, etc., thin displays and cover lenses (cover glass) used in portable information terminals such as smartphones, smart watches and other wearable terminals.

### DESCRIPTION OF REFERENCE SIGNS

2,2B: Workpiece
2a: Outer circumferential edge face
3: Film-forming liquid
10, 10A, 10B, 10C: Coating apparatus
11, 11A: Support base
12: Bracket
12a: Arm
13: First sliding part
13a: Linear guide
13b: Slider
14: First attaching board
15: Second attaching board
16: Air cylinder
16a: Rod
17: Joint
18: L-type Connection tool
20, 20A: Rotating mechanism
21, 21A: Holding part
22, 22A: Imitating form
22a: Outer circumferential edge face
22b: Insertion hole
22c: Attachment hole
22d: Pressing roller guide
23: Imitating form attachment part
24: First rotating shaft
25: Second rotating shaft
26: Suction path
27: Driver
27a: Belt pulley mechanism
28: Third rotating shaft
28a: Holding part attachment
28b: Imitating form attachment part
29: Housing
30, 30A, 30B, 30C: Coating mechanism
31,31A: Pressing roller
31b: Roller shaft
31c: Smaller diameter bearing
32, 32A: Coating part
33, 33A: Coating roller
33a: Outer circumferential edge face
33b: Roller shaft
33c: Outer circumferential edge part
34, 34A: Liquid supply section
34a: Coating base part
34aa: Liquid reserve part
34ab: Tapered shape part
34b: Spacer
34ba: Hole
34bb: Slit hole
34c: Coating block
34ca: Tube part
34cb: Tapered shape part
34d: Liquid channel
35: Liquid scraper part
35A: Bar coater (Liquid expansion part)
35B: Squeegee (Liquid scraper)
35a: Coating groove
36,36A: Liquid receiver
37: Housing
40: Rotary transmission unit
41: First transmission unit
41a: Pressing roller rotating shaft
41b: First gear (First rotary transmission part)
42: Second transmission unit
42a: Rotary transmission shaft (First rotary transmission shaft)
42b: Second gear (Second rotary transmission part)
42c: Third gear (Third rotary transmission part)
43: Third transmission unit
43a: Coating roller rotating shaft
43b: Fourth gear (Forth rotary transmission part)
43c: Swaying arm
44: Attaching member
50,50A: Imitating position adjustment mechanism
51: Moving mechanism
51a: Guide rail
51b: Slider
52: Attaching member pressing part
52a: Piston rod
60,60A: Coating roller pressing part
61,61A: Elastic member
62,62A: Attaching member
70,70A,70B: Rotary transmission unit
71: Fourth transmission unit
71a: Rotary transmission shaft
71b: Fifth gear (Fifth rotary transmission part)
72,72A,72B: Fifth transmission unit
72a: Sixth gear (Sixth rotary transmission part)
72b: Seventh gear (Seventh rotary transmission part)
72c: Rotary transmission shaft (Second rotary transmission shaft)
72d: Deflectable shaft
72e: Sixth gear shaft
72f: Seventh gear shaft
73: Eighth gear (Eighth rotary transmission part)
74: Driving motor (Driving part)
74A: First driving motor (First driving part)
74B: Second driving motor (Second driving part)
74a: Rotating shaft
75: Motor attaching board
76: Housing
77: Second sliding part
78: Ninth gear (Ninth rotary transmission part)
D1: First direction
D2: Second direction
D3: Third direction
D4: Fourth direction

1. A coating apparatus comprising a rotating mechanism that rotates a workpiece and a coating mechanism that applies the film-forming liquid to the outer circumferential edge face of the workpiece comprising:
the rotating mechanism can synchronously rotate the workpiece and the imitating form having almost identical outline to the outline of the workpiece, at the same rotating axis center; and
the coating mechanism comprising:
a pressing roller that can rotate with the imitating form while being pressed against the outer circumferential edge face of the imitating form;
a coating part including a coating roller that is pressed against the outer circumferential edge face of the workpiece and rotates with the workpiece to apply the film-forming liquid to the outer circumferential edge face of the workpiece; and
a rotary transmission unit that synchronously rotates the pressing roller and the coating roller, which have almost identical outline.

2. The coating apparatus according to claim 1, wherein the coating mechanism comprises:
a copying position adjustment mechanism that enables adjustment of the position of the pressing roller so that it moves along the outer circumferential edge face of the imitating form, while synchronizing the change in the distance from the center of rotation of the imitating form to the contact point between the imitating form and the pressing roller accompanied by rotation of the imitating form.

3. The coating apparatus according to claim 2, wherein the copying position adjustment mechanism comprises:
a moving mechanism that enables the attaching member to which the pressing roller, the coating part and the rotary transmission unit are operably attached to move in a first direction along a straight line connecting the center of rotation of the imitating form and the center of rotation of the pressing roller; and
a pressing adjustment part that enables the pressing adjustment of the attaching member attached to the moving mechanism in the first direction.

4. The coating apparatus according to claim 2, wherein the coating mechanism comprises:
a coating roller pressing part, which adjust the power of pressing coating roller to the outer circumferential edge face of the workpiece.

5. The coating apparatus according to claim 4, wherein the coating roller pressing part comprises:
a elastic member, which arranged with variable force in a second direction along a straight line connecting the center of rotation of the workpiece and the center of rotation of the coating roller.

6. The coating apparatus according to claim 1, wherein the rotary transmission unit comprises:
a first transmission unit for transmitting the rotation of the pressing roller;
a second transmission unit for transmitting the rotation from the first transmission unit; and
a third transmission unit for transmitting the rotation from the second transmission unit to the coating roller, wherein the first transmission unit comprises:
a first rotary transmission part for rotating together with the shaft of rotation of the pressing roller, wherein the second transmission unit comprises:
a first rotary transmission shaft which is attached to a second rotary transmission part rotating synchronously with the first rotary transmission part at one end and a third rotary transmission part rotating synchronously with the second rotary transmission part at the other end, wherein the third transmission unit comprises:
a fourth rotary transmission part which is attached to the rotating shaft of the coating roller and rotates synchronously with the third rotary transmission part; and
a swaying arm that supports the rotating shaft of the coating roller in a form that enables the coating roller to sway around the first rotary transmission shaft.

7. The coating apparatus according to claim 1, wherein the coating part comprises:
a liquid supply section to supply film-forming liquid to the outer circumferential edge face of the coating roller; and
a liquid scraper provided with a coating groove to form a coating width less than or equal to the thickness of the workpiece and arranged to be in contact with the outer circumferential edge face of the coating roller.

8. The coating apparatus according to claim 1, wherein the rotating mechanism comprises:
a holding part to hold the workpiece; and
a imitating form attachment part to which the imitating form is removably attached.

9. The coating apparatus according to claim 8, wherein the rotating mechanism comprises:
a first rotating shaft connecting the holding part and the imitating form attachment part; and
a second rotating shaft connected coaxially to the first rotating shaft and rotatable by a rotary drive force from a driver, wherein
the holding part, the first rotating shaft and the second rotating shaft have a suction path for adsorbing and holding the workpiece in the holding part.

10. The coating apparatus according to claim 1, wherein the outer circumference length of the pressing roller is longer than the outer circumference length of the imitating form.

11. The coating apparatus according to claim 1, wherein the rotary transmission unit comprises:
a fourth transmission unit that has a fifth rotary transmission part having the same outline as the coating roller and enables synchronized rotation of the fifth rotary transmission part and the coating roller around the same rotating axis center; and
a fifth transmission unit that enables synchronized rotation of the pressing roller and the fifth rotary transmission part.

12. The coating apparatus according to claim 11, wherein the fifth transmission unit comprises:
a sixth rotary transmission part that can rotate together with the pressing roller;
a seventh rotary transmission part that has the same outline as the sixth rotary transmission part and can rotate together with the fifth rotary transmission part; and
a second rotary transmission shaft that enables synchronized rotation of the sixth and seventh rotary transmission part.

13. The coating apparatus according to claim 12, wherein
the second rotary transmission shaft comprises a deflectable shaft or a universal joint.

14. The coating apparatus according to claim 12, wherein the rotary transmission unit comprises:
a eighth rotary transmission part rotatable together with the sixth rotary transmission part; and
a driving part that rotates and drives the eighth rotary transmission part.

15. The coating apparatus according to claim 14, wherein
a tooth profile is formed on the outer surface of each of the imitating form, the pressing roller, the fifth rotary transmission part, the sixth rotary transmission part, the seventh rotary transmission part and the eighth rotary transmission part, which can be engaged with each other.

16. The coating apparatus according to claim 11, wherein the fifth transmission unit comprises:
a sixth rotary transmission part that can rotate together with the pressing roller;
a seventh rotary transmission part that has the same outline as the sixth rotary transmission part and can rotate together with the fifth rotary transmission part;
a first driving part that rotates and drives the sixth rotary transmission part; and
a second driving part that rotates and drives the seventh rotary transmission part.

17. The coating apparatus according to claim 16, wherein
a tooth profile is formed on the outer surface of each of the imitating form, the pressing roller, the fifth rotary transmission part, the sixth rotary transmission part and the seventh rotary transmission part, which can be engaged with each other.

18. The coating apparatus according to claim 11, wherein the fifth transmission unit comprises:
a sixth rotary transmission part that can rotate together with the pressing roller;
a seventh rotary transmission part that has the same outline as the sixth rotary transmission part and can rotate together with the fifth rotary transmission part;
a eighth rotary transmission part rotatable together with the sixth rotary transmission part:
a first driving part that rotates and drives the eighth rotary transmission part;
a ninth rotary transmission part rotatable together with the seventh rotary transmission part; and
a second driving part that rotates and drives the ninth rotary transmission part.

19. The coating apparatus according to claim 18, wherein
a tooth profile is formed on the outer surface of each of the imitating form, the pressing roller, the fifth rotary transmission part, the sixth rotary transmission part, the seventh rotary transmission part, the eighth rotary transmission part and the ninth rotary transmission part, which can be engaged with each other.

20. The coating apparatus according to claim 1, wherein the rotary transmission unit comprises:
a first driving part that rotates and drives the pressing roller; and
a second driving part that rotates and drives the coating roller.

21. The coating apparatus according to claim 11, wherein
the imitating form is shaped with a curved section on its periphery,
the radius of the pressing roller is set to be less than or equal to the minimum radius of curvature of the curved section of the imitating form.

22. The coating apparatus according to claim 21, wherein
a pressing roller guide is mounted on the imitating form,
the pressing roller guide is configured to guide the pressing roller along the curved section of the imitating form.

23. The coating apparatus according to claim 11, wherein the rotating mechanism comprises:
a holding part to hold the workpiece;
a third rotating shaft with a holding part attachable on one end and a imitating form attachable on the other end; and
a support part that rotatably supports the third rotating shaft, wherein
the holding part and the third rotating shaft have a suction path for adsorbing and holding the workpiece in the holding part.

24. The coating apparatus according to claim 11, wherein
the thickness of the outer circumferential edge face of the coating roller is less than or equal to the thickness of the outer circumferential edge face of the workpiece, wherein the coating part comprises:
a liquid supply section to supply the film-forming liquid to the outer circumferential edge face of the coating roller;
a liquid expansion part arranged to be in contact with the outer circumferential edge face of the coating roller; and
a liquid scraper arranged to be in contact with the outer circumferential edge face of the coating roller.

25. The coating apparatus according to claim 24, wherein
the liquid expansion part has a plurality of micro-grooves formed in the direction of rotation of the coating roller on the contact surface with the outer circumferential edge face of the coating roller.
